(19) United States
(12) Patent Application Publication
(10) Pub. No.: US 2006/0013127 A1
(43) Pub. Date: Jan. 19, 2006

(54) MPLS network system and node

(75) Inventors: Noritake Izaiku, Yokohama (JP); Wakana Matsumoto, Yokohama (JP)

Correspondence Address: SWIDLER BERLIN LLP, 3000 K STREET, NW, BOX IP, WASHINGTON, DC, 20007, US

(73) Assignee: FUJITSU LIMITED

(21) Appl. No.: 11/018,761

(22) Filed: Dec. 22, 2004

(30) Foreign Application Priority Data
Jul. 15, 2004 (JP) 2004-208059

(51) Int. Cl. H04L 12/26; H04L 12/56; H04L 12/28; H04J 1/16; H04J 3/14; H04L 1/00

(52) U.S. Cl. 370/225; 370/242; 370/392

(57) ABSTRACT

Respective nodes on an MPLS network includes a priority path management section that manages a label, which has been advertised by a neighboring node on a priority path, is designated as a priority transmission label, and is paired with a label advertised by the node itself, a detour path management section that manages a label, which has been advertised by a neighboring node on a detour path, is designated as a detour transmission label, and is paired with a label advertised by the node itself, a failure detection section that detects a failure between the node itself and a neighboring node, and a path switching section that, if a failure is detected, replaces a label attached to data to be forwarded to the neighboring node on the priority path with the detour transmission label instead of the priority transmission label, and forwards the data to the neighboring node on the detour path.

### BACKGROUND OF THE INVENTION

1. Fieled of the Invention

The present invention relates to an MPLS (Multi Protocol Label Switching) network, and nodes which function as a label switching router or label edge router used on this network. More specifically, the present invention relates to an MPLS network including multiple nodes, which function as a label switching router or label edge router having a function of, in case of failure, switching from a failed path to a detour path, and relates to the nodes.

2. Description of the Related Art

Recently, carrier services using the MPLS (Multi Protocol Label Switching) have become widely available. There are RSVP (Resource reservation Protocol) and LDP (Label Distribution Protocol) as representative signaling protocols which serve as a key to the MPLS. Services using the RSVP generally set paths statically on a network, which requires a large amount of work. On the other hand, the LDP can automatically set paths according to dynamic routing information on a network, and the application thereof is thus being considered.

On the MPLS network using the LDP, respective nodes (LSR: Label Switching Router) included therein carry out path switching and path calculation between the node itself and neighboring nodes for respective destinations (FEC: Forwarding Equipment Class), thereby determining paths to the respective destinations (hereinafter referred to as priority paths), and carry out LSP (Label Switching Path) setting and advertisement of labels (transmission of advertisement messages) for the determined priority paths. In a state where the processing as described above has been carried out on the respective nodes, if data (packet) reaches a node (LER: Label Edge Router) on an edge of the MPLS network, the node, which has received the data, attaches a label, which has been advertised by a neighboring node to which an LSP is set according to the destination of the data, to the data, and transmits the data to the neighboring node. The next node (LSR), which has received the data, replaces the label attached to the received data with a label, which has been advertised from a neighboring node to which the LSP is set according to the destination of the data and transmits the data to the neighboring node. As a result of this operation carried out by the respective nodes, the data, which has reached the MPLS network, is forwarded toward the destination sequentially via the respective nodes on the priority path.

The processing including the path switching, path calculation, LSP setting, and label advertisement on the respective nodes is repeated at a predetermined cycle, for example. Each time the processing is carried out, the forwarding paths (LSP's) and the labels to be attached to the forwarded data are determined for the respective destinations on the respective nodes, and stability of the network topology is consequently achieved on the MPLS network.

If a failure occurs on the priority path determined according to a certain destination on the MPLS network, the forwarding path of data is switched from the priority path to a detour path. There have been proposed various technologies used for the path switching on occurrence of failure.

In a first proposed example (refer to Patent document 1, for example), if a failure occurs on a core node (a node other than nodes disposed on edges of a network) on a network, a node, which has detected the failure, transmits a message (withdraw message) up to a terminal node, and a path is detoured to a different path from the terminal node.

Additionally, in a second proposed example (refer to Patent document 2, for example), a node, which has detected a line failure, attaches a special label implying a special meaning to a forwarded data, finds out a detour path, and sends out the data attached with the special label. A node, which has received the data attached with the special label, finds out a detour path on this occasion, and sends out the data with the special label to the detour path in the same manner. Consequently, the data is forwarded sequentially on the detour path found by the respective nodes on the MPLS network.

Further, in a third proposed example (refer to Patent document 3, for example), respective nodes store priority paths and detour paths (paths to neighboring nodes reached by the next hop according to a path protocol such as OSPF/RIP (Open Shortest Path First/Routing Information Protocol) in advance, and a node which detects a line failure switches the forwarding destination of data from the priority path to the detour path. Then, the node, which has not detected a line failure, forwards received data toward the priority path.
[Patent document 1] JP 2003-60680 A
[Patent document 2] JP 2003-134148 A
[Patent document 3] JP 2003-78554 A

However, the conventional examples relating to the path switching in case of failure have the following problems.

In the first example, since switching to protection is carried out after the message reaches the terminal, packets held until the message reaches the terminal are lost, resulting in an increase in a period of a traffic disconnection. In addition, a certain registration operation is necessary for transmitting the special message from the node, which has detected the line failure, to the terminal node on the upstream side, and the amount of work by a maintenance engineer thus increases according to the scale of the network.

Additionally, in the second example, if the number of stages of the nodes increases on the detour path, the periods required for searching for the detour path may be summed up. As a result, the period of the traffic disconnection may increase.

Further, in the third example, since the respective nodes store the priority paths and detour paths in advance, the node, which has detected the line failure, can immediately switch the path for forwarding data from the priority path to the detour path. However, the nodes other than the node which has detected the line failure maintain the priority paths, and the following problem may thus occur.

For example, as shown in FIG. 1, on an MPLS network where a node A→a node B→a node C is set as a priority path P1 for a destination dest1 of data routing through the node A, and a node D→the node A→the node B→the node C is set as a priority path P2 for the same destination dest1 of data routing through the node D, it is assumed that the node A holds a priority path LSP1 directed to the node B and a detour path LSP1′ directed to the node D, and the node D holds a priority path LSP2. On this MPLS network, if the node A detects a failure, which has occurred on the priority path LSP1, the node A switches the data forwarding path from the priority path LSP1 to the detour path LSP1′. As a result, the data for the destination dest1, which has been forwarded from the node A to the node B, is now forwarded to the node D. However, since the node D has not detected the occurrence of the failure, the node D forwards the data for the destination dest1, which has been received from the node A, to the node A through the priority path LSP2. Consequently, until the path for the destination dest1 is reset on the MPLS network, data for the destination dest1, which reaches the node A, repeats a round trip between the node A and node D, resulting in a traffic disconnection during this period.

### SUMMARY OF THE INVENTION

The present invention has been made to solve the aforementioned problem of the prior art, and thus provides an invention adopts the following configurations.

That is, the present invention relates to a multi protocol label switching (MPLS) network system including multiple nodes which functions as a label switching router or a label edge router, in which each of the nodes includes:
priority path MPLS network system and nodes thereof which can reduce a traffic disconnection period as much as possible if a failure occurs.

In order to solve the above-mentioned problems, the present management means that manages a label, which is advertised by a neighboring node corresponding to a next hop on a priority path, designated as a priority transmission label, and paired with a label advertised by the node itself;
first detour path management means that manages a label, which is advertised by a neighboring node corresponding to a next hop on a first detour path, designated as a detour transmission label, and paired with a label advertised by the node itself;
failure detection means that detects a failure between the node itself and the neighboring node; and
first path switching means that, if the failure detection means detects a failure between the neighboring node corresponding to the next hop on the priority path and the node itself, replaces the label, which is attached to data to be forwarded to the neighboring node corresponding to the next hop on the priority path and advertised by the node itself, with the detour transmission label instead of the priority transmission label, and forwards the data to the neighboring node corresponding to the next hop on the detour path.

According to such a configuration, if a failure is detected on the priority path to the neighboring node, each node replaces the label, which has been advertised by the node itself and attached to data to be forwarded to the neighboring node on the priority path, with the detour transmission label instead of the priority transmission label, and forwards the data to the neighboring node of the first detour path.

Further, the MPLS network system according to the present invention may be configured such that each of the nodes further includes:
means that advertises a first label to the neighboring node corresponding to the next hop on the priority path; and
means that advertises a second label different from the first label to a neighboring node on a path other than the priority path; and
the first detour path management means manages the detour transmission label which is paired with the first label.

According to such a configuration, if each node receives forwarded data with the first label from a neighboring node, the node can immediately forward the data to a neighboring node on the detour path.

In addition, data attached with the first label is not forwarded to the neighboring node on the priority path, making it possible to prevent the data from being repeatedly forwarded between the node itself and the neighboring node on the priority path.

Further, the MPLS network system according to the present invention may be configured such that:
each of the nodes further includes:
label monitoring means that monitors a label, which has been advertised by the node itself and attached to the data forwarded from the neighboring node; and
second path switching means that, if the label monitoring means detects that the label which has been advertised from the node itself is the first label, replaces the first label attached to the forwarded data with the detour transmission label, and forwards the data to a neighboring node corresponding to a next hop on the first detour path.

Further, the MPLS network system according to the present invention may include:
label monitoring means that monitors the label which is attached to the data forwarded by a neighboring node and advertised by the node itself;
second path switching means that, if the label monitoring means detects that the label which is advertised by the node itself is the first label, replaces the first label, which is attached to the forwarded data, with the detour transmission label, and forwards the data to the neighboring node corresponding to the next hop on the first detour path.

According to such a configuration, since the source node, which forwards the data attached with the first label, is carrying out the data forwarding to the first detour path, the respective nodes can immediately forward the data to the first detour path in a similar manner.

Further, the present invention relates to a node which functions as a label switching router or a label edge router constituting a multi protocol label switching (MPLS) network, including:
priority path management means that manages a label, which is advertised by a neighboring node corresponding to a next hop on a priority path, designated as a priority transmission label, and paired with a label advertised by the node itself;
first detour path management means that manages a label, which is advertised by a neighboring node corresponding to a next hop on a first detour path, designated as a detour transmission label, and paired with a label advertised by the node itself;
failure detection means that detects a failure between the node itself and a neighboring node; and
first path switching means that, if the failure detection means detects the failure between the neighboring node corresponding to the next hop on the priority path and the node itself, replaces the label, which is attached to data to be forwarded to the neighboring node corresponding to the next hop on the priority path and advertised by the node itself, with the detour transmission label instead of the priority transmission label, and forwards the data to the neighboring node corresponding to the next hop on the detour path.

The node according to the present invention may further include:
means that advertises a first label to the neighboring node corresponding to the next hop on the priority path; and
means that advertises a second label different from the first label to a neighboring node on a path other than the priority path, and may be configured such that the first detour path management means manages the detour transmission label which is paired with the first label.

On the MPLS network system according to the present invention, if a failure is detected on the priority path to the neighboring node, it is possible to immediately forward data, which is to be forwarded to the neighboring node on the priority path, to the neighboring node on the first detour path by means of controlling the label to be attached to the data to be forwarded, thereby reducing the traffic disconnection period, and easily switching the paths.

### BRIEF DESCRIPTION OF THE DRAWINGS

FIG. 1 is a diagram showing conventional path switching on an MPLS network;

FIG. 2 is a diagram showing a configuration of an MPLS network according to a first embodiment of the present invention;

FIG. 3 is a block diagram showing a functional configuration of respective nodes on the MPLS network shown in FIG. 1;

FIG. 4 is a sequence diagram (part 1) showing a processing procedure on the respective nodes before a failure;

FIG. 5 is a sequence diagram (part 2) showing the processing procedure on the respective nodes before a failure;

FIG. 6 is a diagram showing a state where a failure occurs on the MPLS network shown in FIG. 1;

FIG. 7 is a sequence diagram showing a processing procedure on a node B when the failure in FIG. 6 occurs;

FIG. 8 is a sequence diagram showing a processing procedure on a node F after the failure in FIG. 6 occurs;

FIG. 9 is a diagram showing a state of the MPLS network after the failure occurs;

FIGS. 10a-10e are tables showing registered data 1 to 5 on the node B in respective states before, during, and after the failure;

FIGS. 11a-11e are tables showing registered data 1 to 5 on the node F in respective states before, during, and after the failure;

FIG. 12 is a diagram showing a configuration of an MPLS network according to a second embodiment of the present invention;

FIG. 13 is a sequence diagram showing a processing procedure on a node, to which the next detour path is set, before a failure;

FIG. 14 is a diagram showing a state where a failure occurs on the MPLS network shown in FIG. 12;

FIG. 15 is a sequence diagram showing a processing procedure on the node B when the failure in FIG. 14 occurs;

FIG. 16 is a sequence diagram showing a processing procedure on the node F when the failure in FIG. 14 occurs;

FIG. 17 is a sequence diagram showing a processing procedure on the node F after the failure in FIG. 14 occurs;

FIG. 18 is a sequence diagram showing a processing procedure on a node H after the failure in FIG. 14 occurs;

FIG. 19 is a diagram showing a state of the MPLS network after the failure occurs;

FIGS. 20a-20f are tables showing registered data 1 to 6 on the node B in respective states before, during, and after the failure;

FIGS. 21a-21f are tables showing registered data 1 to 6 on the node F in respective states before, during, and after the failure;

FIGS. 22a-22f are tables showing registered data 1 to 6 on the node H in respective states before, during, and after the failure;

FIG. 23 is a diagram showing the configuration of an MPLS network according to a third embodiment of the present invention;

FIG. 24 is a sequence diagram showing a processing procedure on respective nodes before a failure;

FIG. 25 is a diagram (part 1) showing a state where a failure occurs on the MPLS network shown in FIG. 23;

FIG. 26 is a sequence diagram showing a processing procedure on a node which detects the failure;

FIG. 27 is a sequence diagram showing a processing procedure on a node other than the node which detects the failure when the failure occurs;

FIG. 28 is a diagram (part 2) showing the state where the failure occurs on the MPLS network shown in FIG. 23;

FIG. 29 is a sequence diagram showing a processing procedure on the respective nodes after the failure occurs;

FIG. 30 is a diagram showing a state of the MPLS network after the failure occurs;

FIGS. 31a-31e are tables showing registered data 1 to 5 on the node B in respective states before, during, and after the failure;

FIGS. 32a-32e are tables showing registered data 1 to 5 on the node F in respective states before, during, and after the failure; and

FIGS. 33a-33e are tables showing registered data 1 to 5 on a node G in respective states before, during, and after the failure.

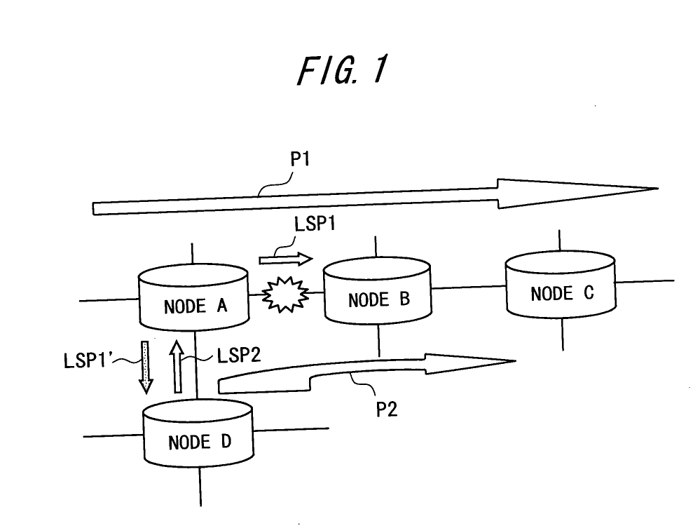

### DESCRIPTION OF THE PREFERRED EMBODIMENTS

A description will now be given of embodiments of the present invention with reference to drawings. The configurations of the following embodiments are provided by way of example, and the present invention is thus not limited to the configurations of the embodiments.

### First Embodiment

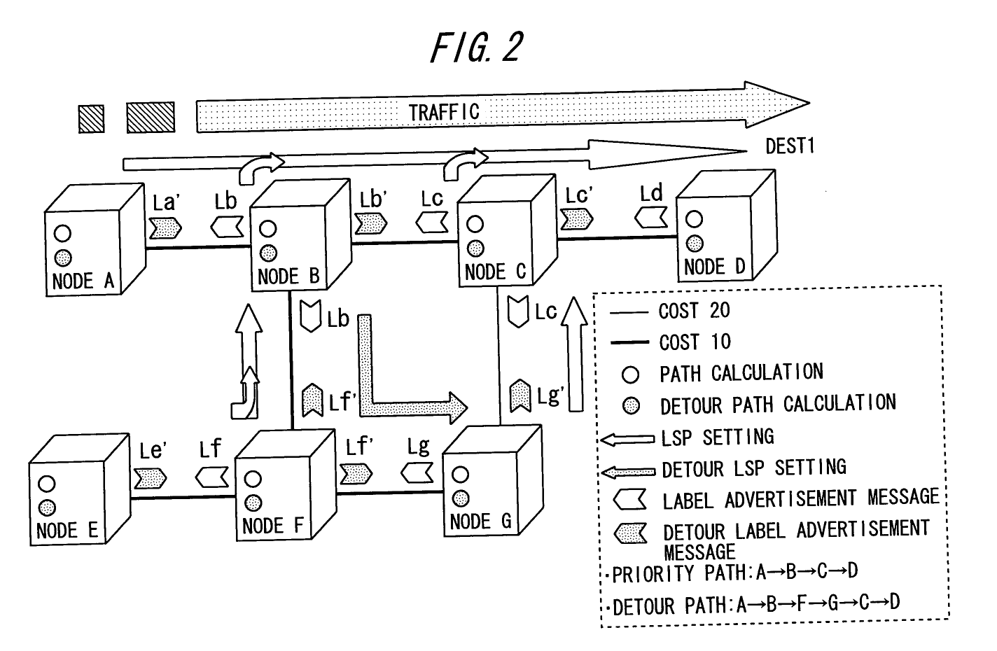

An MPLS network according to a first embodiment of the present invention is configured as shown in FIG. 2, for example.

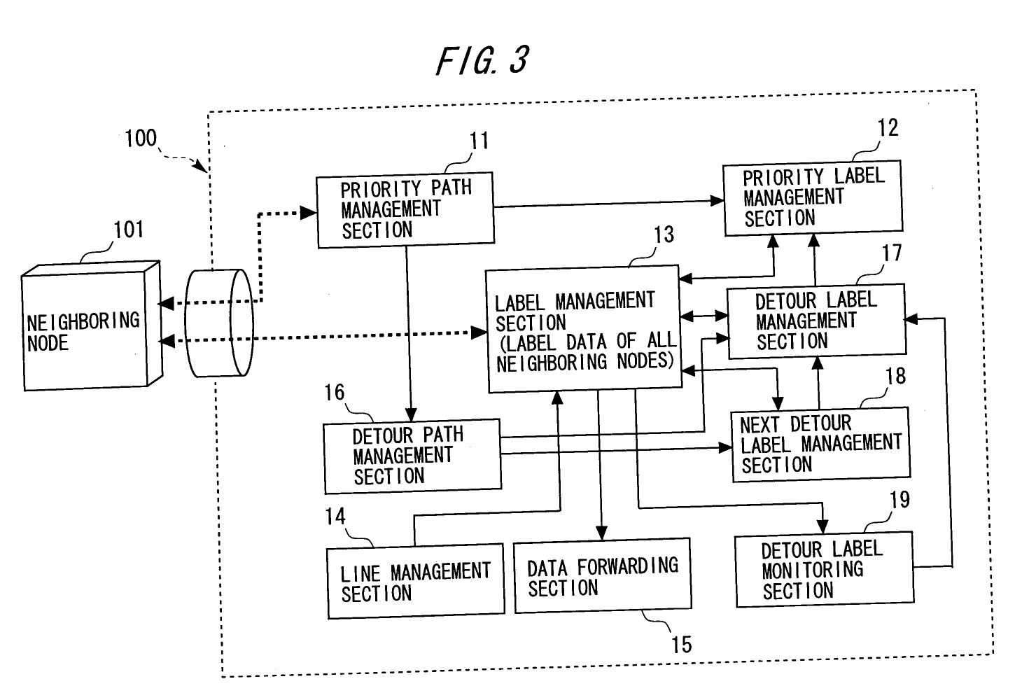

In FIG. 2, this MPLS network includes seven nodes, a node A to a node G, which respectively function as a label switching router (LSR) or a label edge router (LER), the node C and node F neighbor the node B; the node E, node B, and node G neighbor the node F; the node B, node G, and node D neighbor the node C. The each node is configured to include components shown in FIG. 3. In FIG. 3, a node (LSR or LER) 100 includes a priority path management section 11, a priority label management section 12, a label management section 13, a line management section 14, a data forwarding section 15, a detour path management section 16, a detour label management section 17, a next detour label management section 18, and a detour label monitoring section 19.

The priority path management section 11 exchanges path information with neighboring nodes, thereby determining paths for respective destinations, which have the highest priority of paths toward the destinations, namely priority paths. The priority label management section 12 manages label information on the determined priority paths. The label management section 13 exchanges label information with the neighboring nodes, stores the label information from the entire neighboring nodes, and manages next hops (neighboring nodes on determined paths toward the destinations), labels for the next hops, and the priorities of the paths. The line management section 14 manages the state of lines accommodated by the node (LSR). The data forwarding section 15 manages path information (information on the LSP's) used for forwarding data (packets), and forwards data according to the path information (information on the LSP's) if the data is received. The detour path management section 16 determines paths having priorities next to the priority paths as detour paths, and manages information on neighboring nodes on the detour paths toward the destinations, and the costs of the detour paths. The detour label management section 17 manages transmission/reception labels toward the destinations on the detour paths, sets detour LSP's, changes the detour LSP's to priority LSP's in case of line failure, changes the detour LSP's in case of line failure, and changes the priority LSP's by means of detecting detour labels.

The next detour label management section 18 manages transmission labels of next detour paths, which have a priority next to that of the detour paths, and nodes (next hops) on the next detour paths toward the destinations. If a failure occurs on a line of the detour path, the next detour label management section 18 then requests for setting a detour LSP using the transmission label. The detour label monitoring section 19 monitors a label attached to forwarded data, and simultaneously manages reception labels used for the detour LSP's. If the detour label monitoring section 19 receives data (packet) attached with this reception label, the detour label monitoring section 19 requests for switch of setting from a detour LSP to a priority LSP.

Note that the functions of the next detour label management section 18 and the detour label monitoring section 19 are not effectively used on the respective nodes on the MPLS network according to the first embodiment.

Note that the priority path management section 11, the priority label management section 12, and the label management section 13 function as priority path management means according to the present invention, and the label management section 13, the detour path management section 16, and the detour label management section 17 function as detour path management means. In addition, the data forwarding section 15 functions as first path switching means.

Additionally, the node 100 has a function of advertising reception labels for respective destinations to neighboring nodes. For example, this label advertising function (means for advertising labels) can be realized by the label management section 13. Note that if there are multiple paths (routes) to one destination, the node according to the present embodiment advertises a first label to a neighboring node corresponding to the next hop on the priority path (path with the lowest cost to the destination, for example), and advertises a second label different from the first label to the other neighboring nodes. The first label and the second label may have values different from each other, or may be of label types different from each other.

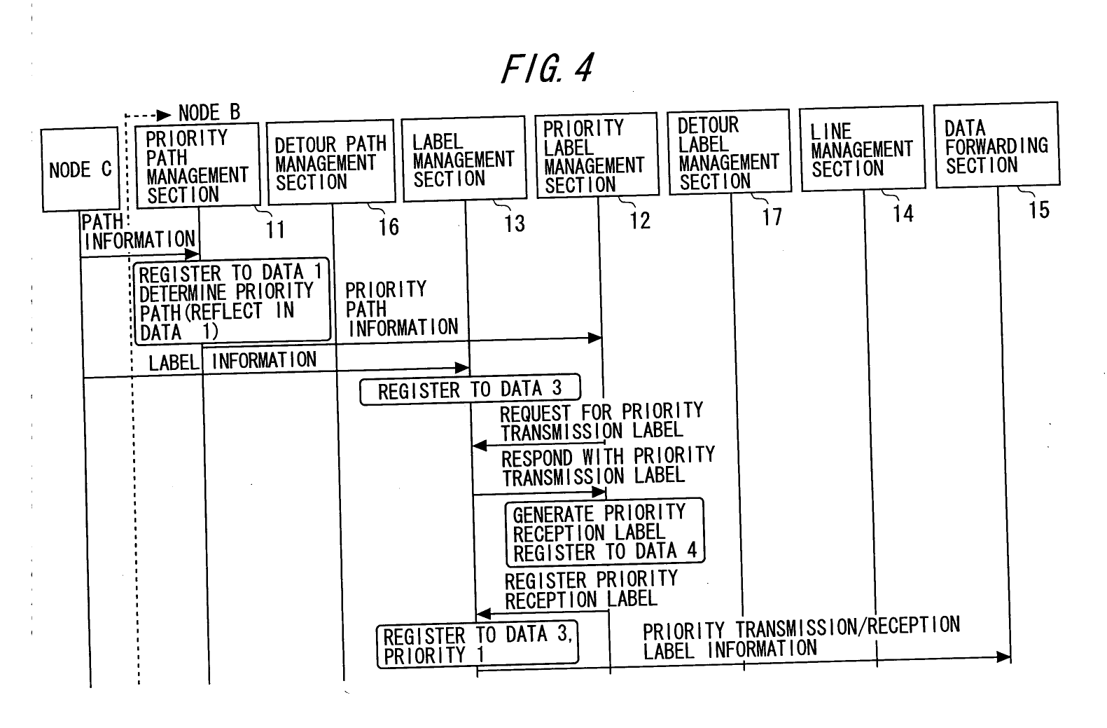

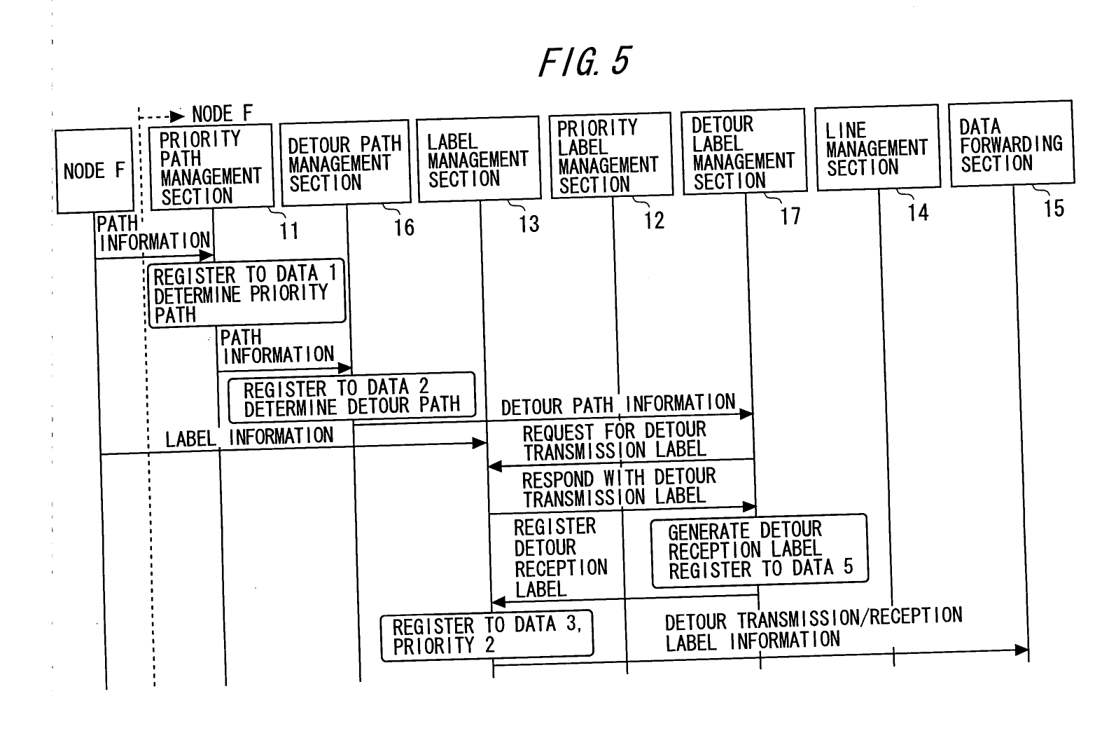

The respective nodes on the MPLS network configured as described above carry out processing according to procedures shown in FIG. 4 and FIG. 5 before starting forwarding of data. Note that although FIG. 4 and FIG. 5 show the processing on the node B on the network shown in FIG. 2, similar processing is carried out on other nodes. In addition, FIG. 4 shows the processing on the node B based on exchange of path information and information on labels with the neighboring node C, and FIG. 5 shows the processing on the node B based on exchange of path information and information on labels with the neighboring node F.

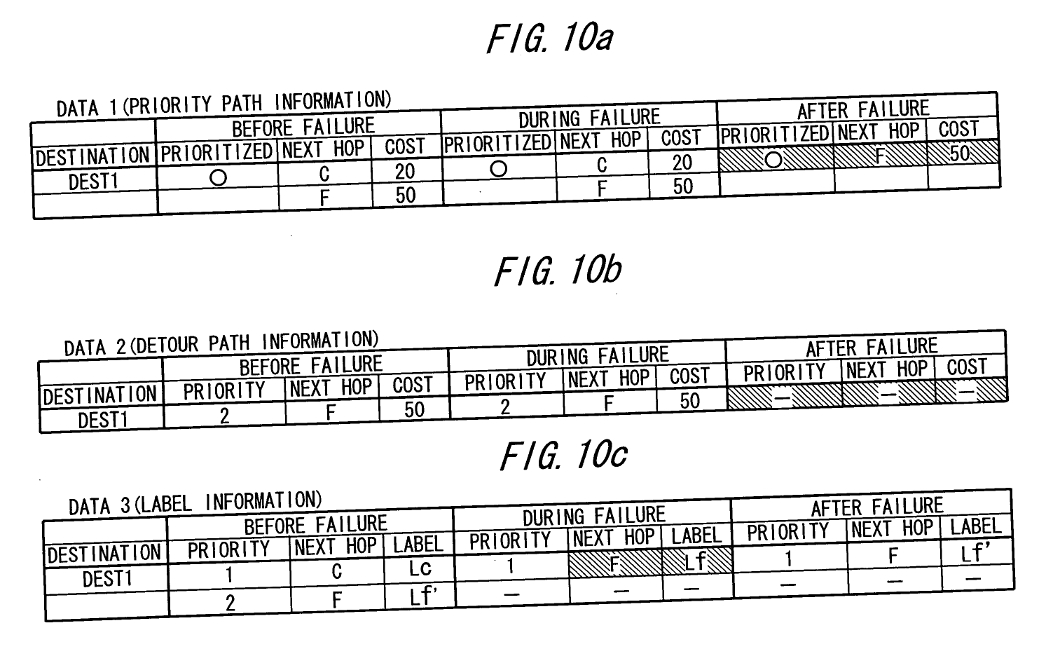

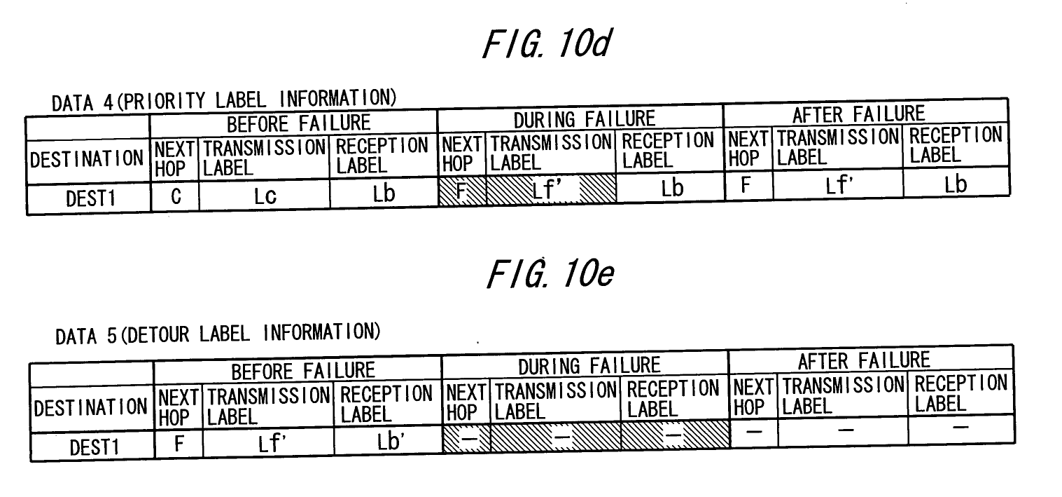

Note that the priority path management section 11 of FIG. 3 manages a table which stores data 1 (priority path information) shown in FIG. 10(a), and the detour path management section 16 manages a table which stores data 2 (detour path information) shown in FIG. 10(b). In addition, the label management section 13 manages a table which stores data 3 (label information) shown in FIG. 10(c), the priority label management section 12 manages a table which stores data 4 (priority label information) shown in FIG. 10(d), and the detour label management section 17 manages a table which stores data 5 (detour label information) shown in FIG. 10(e). These tables are created on a storage apparatus (not shown) constituting the node. These tables are created and managed by the respective nodes.

In FIG. 4 and FIG. 5, the priority path management section 11 exchanges the path information with the respective neighboring nodes C and F, and registers a destination dest1 shown in FIG. 2, next hops (node C and node F) on two paths, (B→C→D) and (B→F→G→C→D) toward the destination from the node B, and costs of these two paths as the path information to the data 1 as shown in “BEFORE FAILURE” in FIG. 10(a).

Note that it is assumed that the respective costs of lines between the node B and node C, between the node C and node D, between the node B and node F, and between the node F and node G are “10”, and the cost of a line between the node G and node C is “20”. In this case, the cost of the path (B→C→D) is calculated as “20”, and the cost of the path (B→F→G→C→D) is calculated as “50”.

The priority path management section 11 refers to the costs of the respective paths registered as described above, and determines the next hop on the path with the lowest cost as the priority path information, and reflects the priority path information in the data 1 (refer to an item “PRIORITIZED” in “BEFORE FAILURE” in FIG. 10(a)) Based on the cost, the detour path management section 16 prioritizes the paths identified by the path information held by the priority path management section 11 other than the path determined as the priority path information, and registers path information (next hop and cost) on a path with the highest priority (with the lowest cost) as detour path information to the data 2 as shown in “BEFORE FAILURE” in FIG. 10(b).

The label management section 13 exchanges the information on the labels with the neighboring nodes. In the exchange of the information on the labels on the respective nodes, the respective nodes differentiate a value of the label advertised to the neighboring node (next hop) on the priority path toward the destination dest1 and a value of the label advertised to the other neighboring nodes from each other.

For example, in FIG. 2, the node B transmits a label advertisement message with a label value Lb′ (corresponding to a first label) to the neighboring node C on the priority path (B→C→D) toward the destination dest1, and transmits a label advertisement message with a label value Lb (corresponding to a second label) to the other neighboring nodes A and F. Additionally, the node F transmits a label advertisement message with a label value Lf′ (corresponding to the first label) to the neighboring node B on the priority path (F→B→C→D) toward the destination dest1, and transmits a label advertisement message with a label value Lf (corresponding to the second label) to the other neighboring nodes E and G. The other nodes in FIG. 2 carry out similar processing.

In the exchange of the information on the labels (label advertisement messages), a label Lc is advertised by the neighboring node C on the path (B→A→C→D, priority path) toward the destination dest1, and the label Lf′ is advertised by the neighboring node F on the path (B→F→G→C→D) toward the destination dest1. Then, the label management section 13 registers the labels advertised by the neighboring nodes C and F as transmission labels attached for the data forwarding to the neighboring nodes C and F along with the destination dest1 and the neighboring nodes (next hops) to the data 3 as shown in “BEFORE FAILURE” in FIG. 10(c).

The priority label management section 12 requests the label management section 13 for a priority transmission label. In response to this request, the label management section 13 retrieves the transmission label of the next hop, which matches the next hop (node C) in the priority path information registered to the data 1, from the data 3, and responds with the retrieved result (transmission label Lc for the node C) as the priority transmission label. The priority label management section 12, which has obtained the priority transmission label (transmission label Lc for the node C), sets the priority transmission label and the label Lb, which the node itself (node B) has advertised to the neighboring nodes other than the node C, as a priority reception label, to the data 4 as shown in “BEFORE FAILURE” in FIG. 10(d).

The priority label management section 12 notifies the label management section 13 of the priority reception label Lb and the next hop (node C) on the priority path. The label management section 13 sets a priority 1 to the next hop (node C) in the data 3 (refer to “BEFORE FAILURE” in FIG. 10(c)), and registers a combination of the priority transmission label Lc and the priority reception label Lb as a priority LSP to the data forwarding section 15.

The detour label management section 17 obtains the detour path information (next hop: node F) registered to the data 2 (refer to “BEFORE FAILURE” in FIG. 10(b)) from the detour path management section 16, and requests from the label management section 13, a detour transmission label based on the detour path information (next hop: node F). In response to this request, the label management section 13 retrieves the transmission label of the next hop, which matches the next hop (node F) in the detour path information registered to the data 2, from the data 3, and responds with the retrieved result (transmission label Lf′ for the node F) as the detour transmission label. The detour label management section 17 sets the detour transmission label and the label Lb′, which the node itself (node B) has advertised to the next hop (node C) on the priority path, as a detour reception label, to the data 5 as shown in “BEFORE FAILURE” in FIG. 10(e).

The detour label management section 17 notifies the label management section 13 of the detour reception label Lb′ and the next hop (node F) on the detour path. The label management section 13 sets a priority 2 to the next hop (node F) in the data 3 (refer to “BEFORE FAILURE” in FIG. 10(c)), and registers a combination of the priority transmission label Lf′ and the priority reception label Lb′ as a detour LSP to the data forwarding section 15.

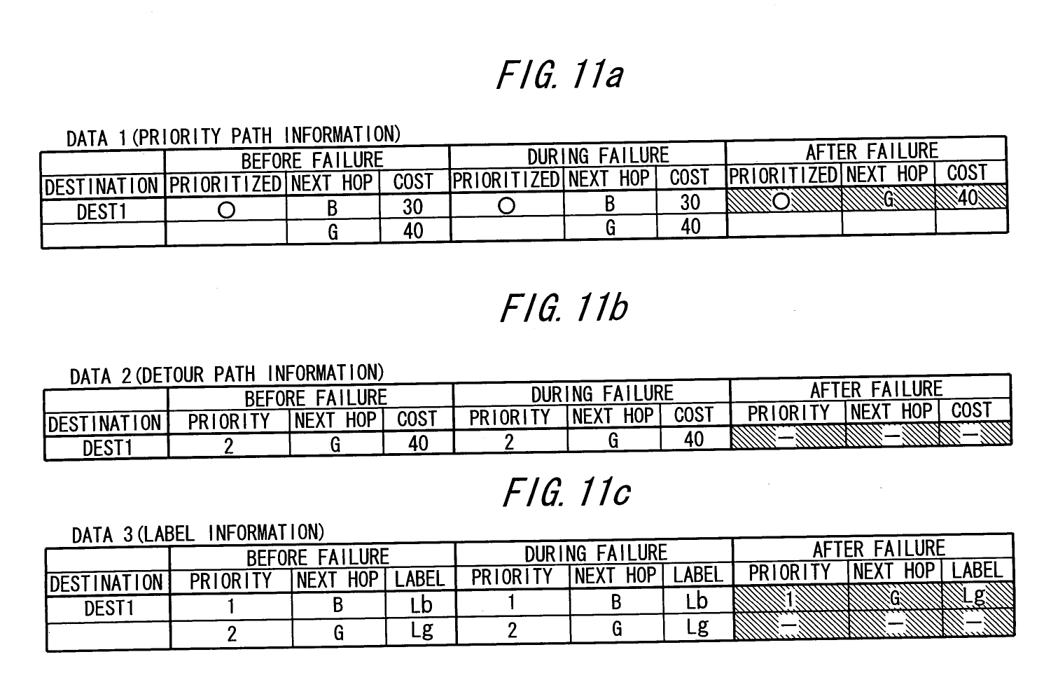

Similar processing is carried out on the node F neighboring to the node B, and various kinds of information are consequently registered to the data 1 (priority path information), data 2 (detour path information), data 3 (label information), data 4 (priority label information), and data 5 (detour label information) as shown in FIG. 11.

In this case, the next hops (node B and node G) on the two paths, (F→B→C→D) and (F→G→C→D), from the node F toward the destination dest1, and the costs of these two paths, which are associated with the destination dest1, are registered to the data 1 (refer to “BEFORE FAILURE” in FIG. 11(a)). Then, the next hop (node B) on the path (F→B→C→D) with a lower cost is set as the priority path information in the data 1. The next hop (node G) on the path (F→G→C→D) with a higher cost is registered as the detour path information in data 2 (refer to “BEFORE FAILURE” in FIG. 11(b)).

As a result of the exchange of the label information with the neighboring nodes, the label Lb advertised by the next hop (node B) on the priority path, and a label Lg advertised by the next hop on the detour path (node G) are registered to the data 3 as the label information (refer to “BEFORE FAILURE” in FIG. 11(c)). Further, in correspondence to the next hop (node B) on the priority path, the reception label Lf on the node itself (node F) and the transmission label Lb for the next hop (node B) are registered to the data 4 as the priority label information (refer to “BEFORE FAILURE” in FIG. 11(d)), and, in correspondence to the next hop (node G) on the detour path, the reception label Lf′ on the node itself (node F) and the transmission label Lg for the next hop (node G) are registered to the data 5 as the detour label information (refer to “BEFORE FAILURE” in FIG. 11(e)). Then, the transmission label Lb and the reception label Lf as the priority label information are registered to the data forwarding section 15 as the priority LSP, and the transmission label Lg and the reception label Lf′ as the detour label information are registered to the data forwarding section 15 as the detour LSP.

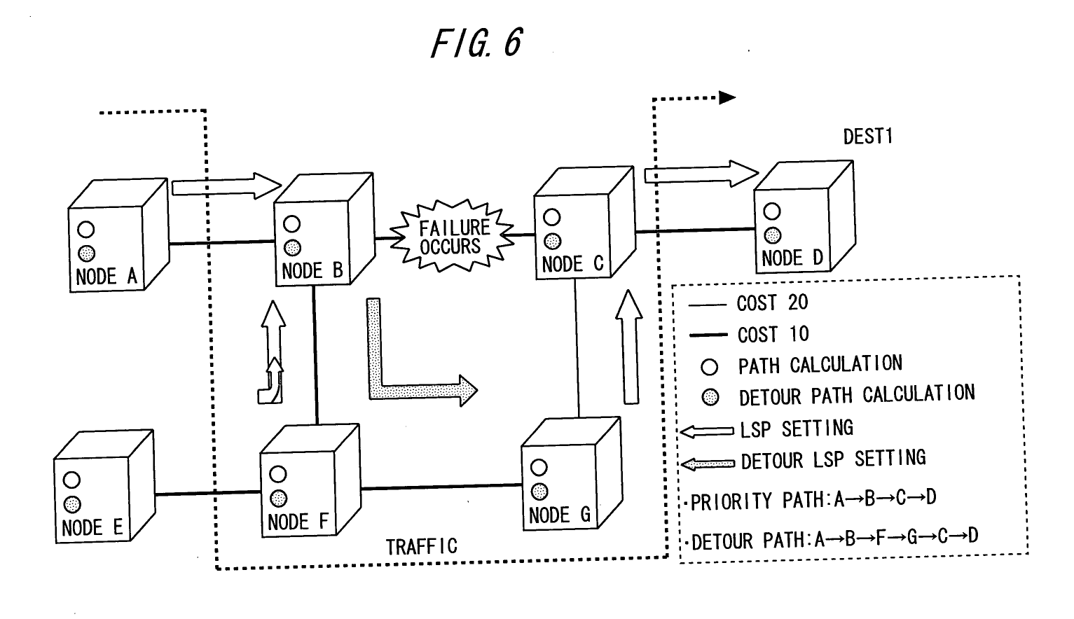

In this way, in a state where the priority LSP and the detour LSP are registered on the data forwarding section 15 on the respective nodes on the MPLS network, if data, which is attached with the label Lb, and is addressed to the dest1, is forwarded by the node A to the node B, for example, the data forwarding section 15 on the node B replaces the label Lb with the label Lc corresponding to the label Lb, and forwards the data to the node C based on the registered priority LSP. On the node C, the label Lc is replaced with a label Ld, and the data is forwarded to the node D. While the labels are being replaced in this way, the data is sequentially forwarded to the dest1 on the priority path (A→B→C→D) In this process, if a failure occurs on the line between the node B and node C as shown in FIG. 6, for example, the following operation is carried out on the MPLS network.

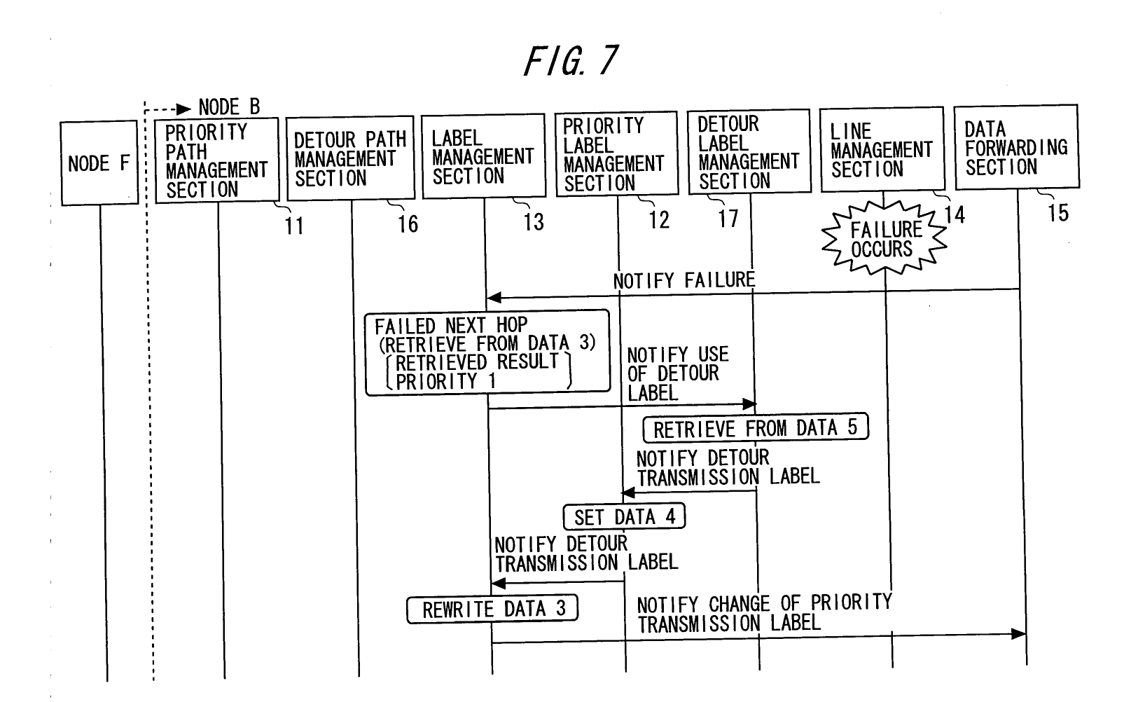

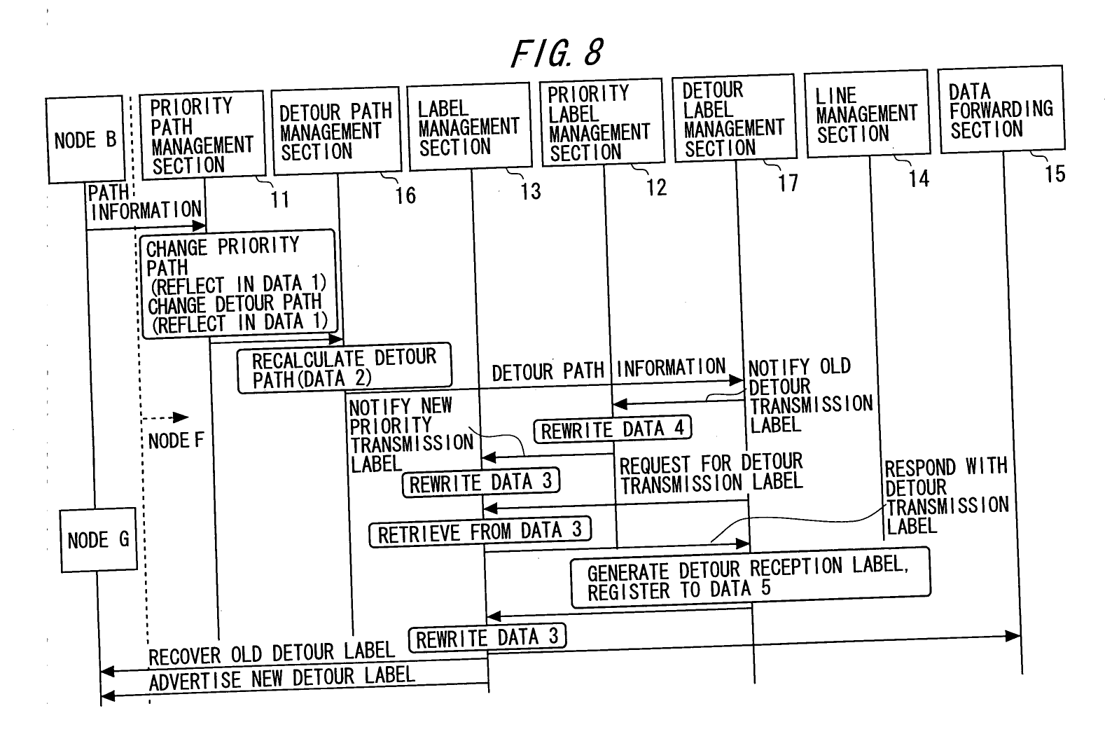

Processing is carried out on the node B, which detects the failure, according to a procedure shown in FIG. 7. In addition, processing is carried out on the node F, which is the next hop on the detour path from the node B toward the destination dest1, according to a procedure shown in FIG. 8.

First, in FIG. 7, if the line management section 14 on the node B detects the failure (detects a disconnection of a physical link between the nodes B and C, for example), the data forwarding section 15 cannot forward data to the next hop (node C), and thus notifies the label management section 13 of information on the next hop (node C) (Notify failure).

The label management section 13 retrieves the notified next hop (node C) from the data 3 (refer to “BEFORE FAILURE” in FIG. 10(c)), and determines whether the next hop (node C) is included in the priority path or not (whether the priority is 1 or not) As a result, if it is determined that the priority is the priority 1, which is highest, the label management section 13 issues a notification for requesting use of the detour label from the detour label management section 17. The detour label management section 17, which has received the notification, obtains the next hop (node F) on the detour path and the detour transmission label Lf′ from the data 5 (refer to FIG. 10(e)), and notifies the priority label management section 12 of them. The detour label management section 17 then deletes the detour label information (next hop, transmission label, and reception label) registered to the data 5 (refer to “DURING FAILURE” in FIG. 10(e)).

The priority label management section 12 rewrites the next hop (node C) on the priority path and the priority transmission label Lc thereof, which have been registered to the data 4, with the notified next hop (node F) on the detour path and the detour transmission label Lf′ (refer to “BEFORE FAILURE” and “DURING FAILURE” in FIG. 10(d)). Consequently, the next hop (node F) on the detour path and the detour transmission label Lf′ are now set as the priority label information. The transmission label Lf′ and the next hop (node F) set as the priority label information in this way are notified from the priority label management section 12 to the label management section 13. The label management section 13 rewrites the node C with the node F as the next hop in the data 3, and simultaneously rewrites Lc with Lf′ as the corresponding label based on the notified information. The label management section 13 then causes the data forwarding section 15 to rewrite Lc with Lf′ as the priority transmission label of the priority LSP (refer to “Before failure” and “DURING FAILURE” in FIG. 10(c)). The new priority LSP is thus defined by a combination of the transmission label Lf′ and the reception label Lb.

After the switching from the priority path to the detour path is carried out on the node B, which has detected the failure, in the manner as described above, if data, which is attached with the label Lb, and addressed to dest1, is forwarded from the node A to the node B, for example, the data forwarding section 15 on the node B replaces the label Lb with the label Lf′ corresponding to the label Lb, and forwards the data to the node F based on the rewritten priority LSP.

The node F, which has received the data attached with the label Lf′ in this way, can recognize that the data is being forwarded on the detour path, since the reception label Lf′ is not registered to the data 4 as the priority label information (refer to “DURING FAILURE” in FIG. 11(d) (same as “BEFORE FAILURE”)), and is registered to the data 5 as the detour label information (refer to “DURING FAILURE” in FIG. 11(e)). Then, to the next hop (node G) on the detour path is forwarded the data, whose reception label Lf′ is replaced with the transmission label Lg based on the detour LSP (defined by a combination of the transmission label Lg and the reception label Lf′). Processing similar to that on the node F is carried out also on the node G and node C, and consequently, the data, which has been forwarded from the node A to the node B, and is addressed to dest1, is sequentially forwarded through the detour path (B→F→G→C→D) from the node B so as to reach the destination dest1.

After a certain period has elapsed since the line failure, and a timing for path redesign (timing based on generally used path calculation completion time for the OSPF and the like, for example) is reached, for example, the path information and label information are exchanged with the neighboring nodes on the respective nodes on the MPLS network, thereby redesigning the paths for the respective destinations as described above. The respective nodes carry out the processing basically according to the procedures shown in FIG. 4 and FIG. 5. On the nodes on which the paths have been switched are also carried out processing for resetting the priority path and detour path.

This processing is carried out according to a procedure shown in FIG. 8, for example. For example, the priority path management section 11 carries out recalculation according to the path information exchanged with the neighboring nodes, and then changes the priority path in the data 1. Specifically, for example, on the node B is deleted the information on the next hop (node C) on the path on which the failure has occurred, and is set a priority flag to the information on the next hop (node F) on the path which has been the detour path until now (refer to “AFTER FAILURE” in FIG. 10(a)). In addition, on the node F is deleted the information on the next hop (node B) on the path which has been the priority path until now, and is set the priority flag to the information on the next hop (node G) on the path which has been the detour path until now (refer to “After failure” in FIG. 11(a)).

The detour path management section 16 registers a path, which is a next candidate of the paths other than the priority path in the data 1, to the data 2 as a new detour path. Note that a next detour path is not present on the node B and node F, and a new detour path is thus not to be registered (refer to “AFTER FAILURE” in FIG. 10(b), and “AFTER FAILURE” in FIG. 11(b)).

For example, the detour path management section 16 notifies the detour label management section 17 of the change of the detour path on the node F. The detour label management section 16 notifies the priority label management section 12 of the old detour transmission label (Lg) and the next hop (node G) in the data 5, and simultaneously deletes them from the data 5 (refer to “AFTER FAILURE” in FIG. 11(e)). The priority label management section 12, which has received the notification, reflects the information in the data 4 (refer to “AFTER FAILURE” in FIG. 11(d)), and notifies the label management section 13 of the information on the new priority transmission label. The label management section 13 updates the priorities in the data 3 (refer to “AFTER FAILURE” in FIG. 11(c)) The label management section 13 further transmits a label recovery message for the label, which has been advertised to the neighboring node on the new priority path as the detour reception label, and the label advertisement message for the new label.

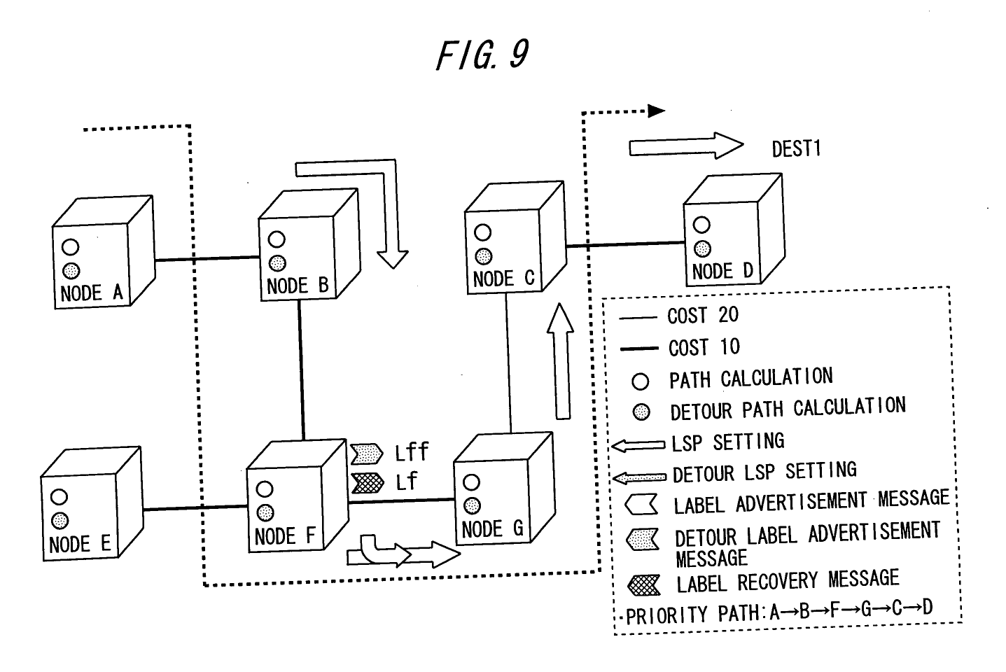

As a result of the processing described above, the data 1 to data 5 on the respective nodes are updated as shown in “AFTER FAILURE” in FIG. 10 and “AFTER FAILURE” in FIG. 11. Consequently, the path (A→B→F→G→C→D) is set as the priority path toward the destination dest1 on the MPLS network as shown in FIG. 9.

According to the first embodiment, the node F advertises the label having the label value (label Lf′), which is different from that of the label (label Lf) to the other neighboring nodes, to the neighboring node corresponding to the next hop on the priority path, and if the node F receives data (packet) attached with the label Lf′ as the transmission label from the node B, the node F forwards the data to the detour LSP set in advance on the assumption that a failure occurs on the priority path. Consequently, it is possible to prevent a traffic disconnection of data due to a generation of the loop between the node B and node F which occurs if the node F forwards the data received from the node B to the node B according to the priority path.

### Second Embodiment

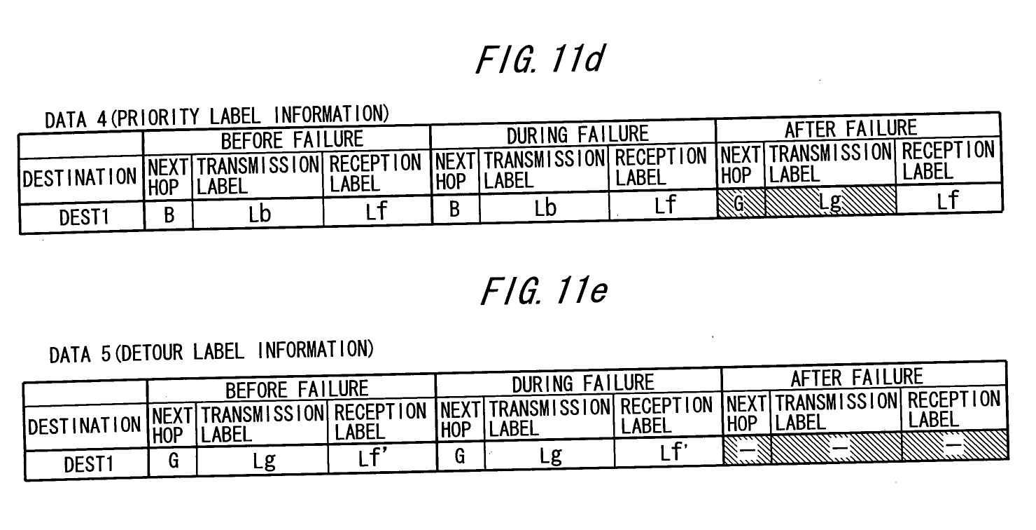

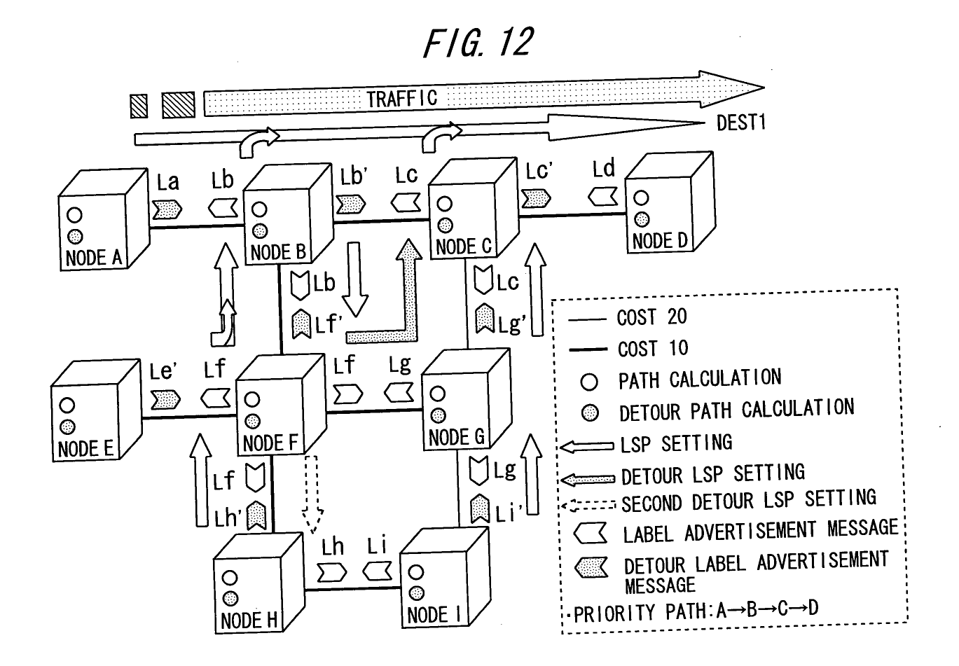

A description will now be given of an MPLS network according to a second embodiment of the present invention. This MPLS network is configured as shown in FIG. 12, for example, and is different from the MPLS network according to the first embodiment in that multiple detour paths are set on the node F for the destination dest1.

In FIG. 12, this MPLS network includes nine nodes A to I, which respectively function as a label switching router (LSR) or a label edge router (LER), and the nodes A to G are connected as on the MPLS network shown in FIG. 2. Further, the node H neighbors the node F and node I, and the node I neighbors the node H and node I. On this MPLS network, of multiple paths from the node A toward the destination dest1, a path (A→B→C→D) is a priority path, and a path (A→B→F→G→C→D) and a path (A→B→F→H→I→G→C→D) are detour paths. The respective nodes are configured as shown in FIG. 3 as in the previous example. Note that the functions of the next detour label management section 18 shown in FIG. 3 are effectively used in the second embodiment.

Note that the label management section 13, the detour path management section 16, and the next detour label management section 18 function as second detour path management means according to the present invention, and the data forwarding section 15 functions as detour path switching means.

The respective nodes carry out the processing according to the procedures shown in FIG. 4 and FIG. 5 before starting the forwarding of data basically in a manner similar to the first embodiment. As a result, on the respective nodes are registered a priority LSP defined by a combination of a priority reception label and a priority transmission label used for the data forwarding to the next hop on the priority path toward the destination dest1, and a detour LSP defined by a combination of a detour reception label and a detour transmission label used for the data forwarding to the next hop on the detour path toward the destination dest1.

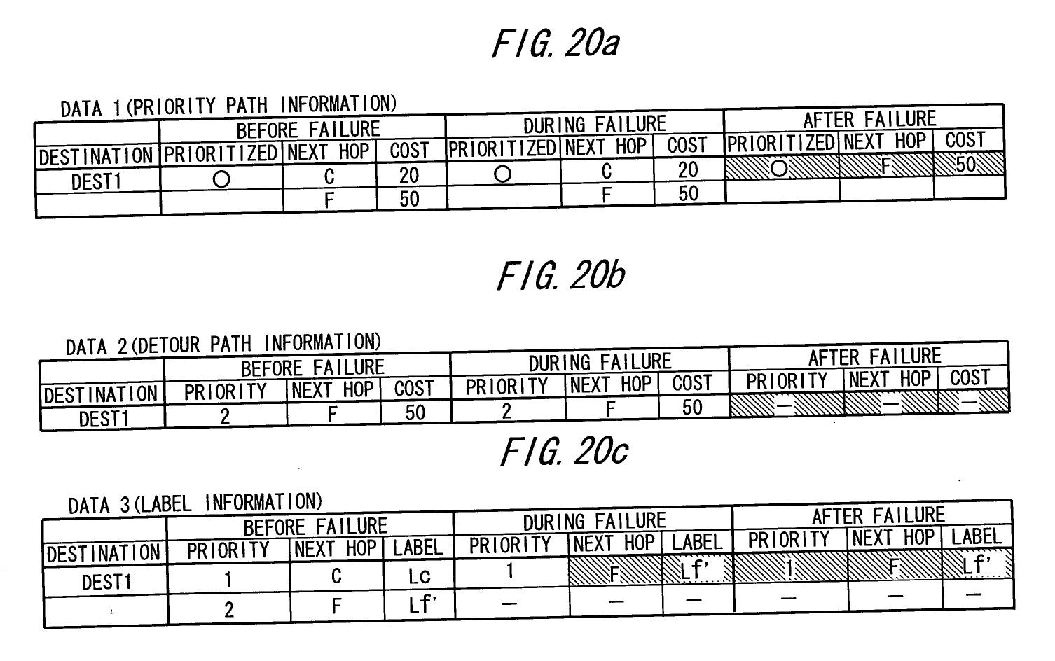

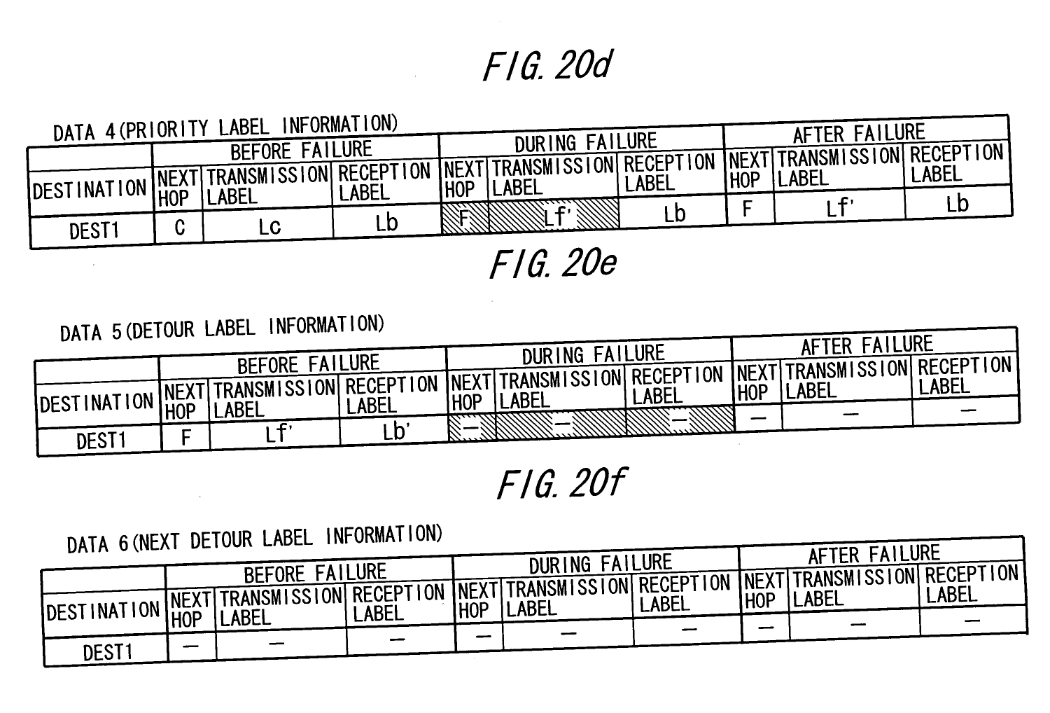

For example, on the node B, as shown in “BEFORE FAILURE” in FIG. 20 (similar to that shown in “Before failure” in FIG. 10), the next hop (node C) on a priority path and the cost thereof and the next hop (node F) on a detour path and the cost thereof are registered to data 1, the next hop (node F) on the detour path, and the cost and a priority 2 thereof are registered to data 2, label information Lc and label information Lf′ advertised by the respective next hops (node C and node F) are registered to data 3, a priority reception label Lb and the priority transmission label Lc for the next hop (node C) on the priority path are registered to data 4, and a detour reception label Lb′ and the detour transmission label Lf′ for the next hop (node F) on the detour path are registered to data 5. Note that a reception label and a transmission label for the next hop on the next detour path are not registered to data 6 on the node B, which has no next detour path.

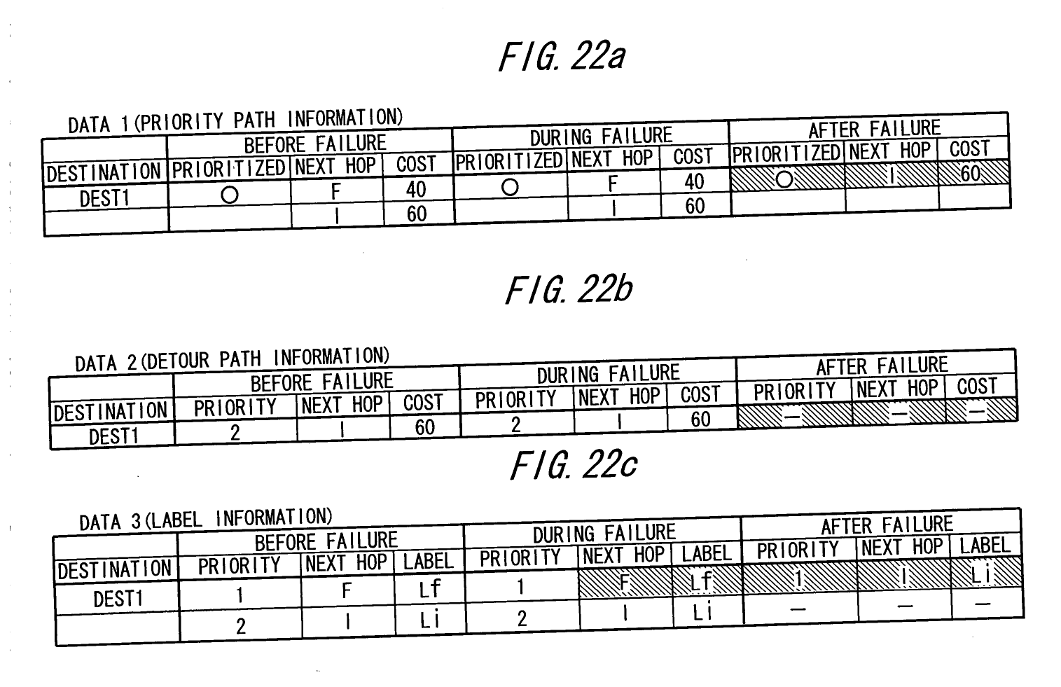

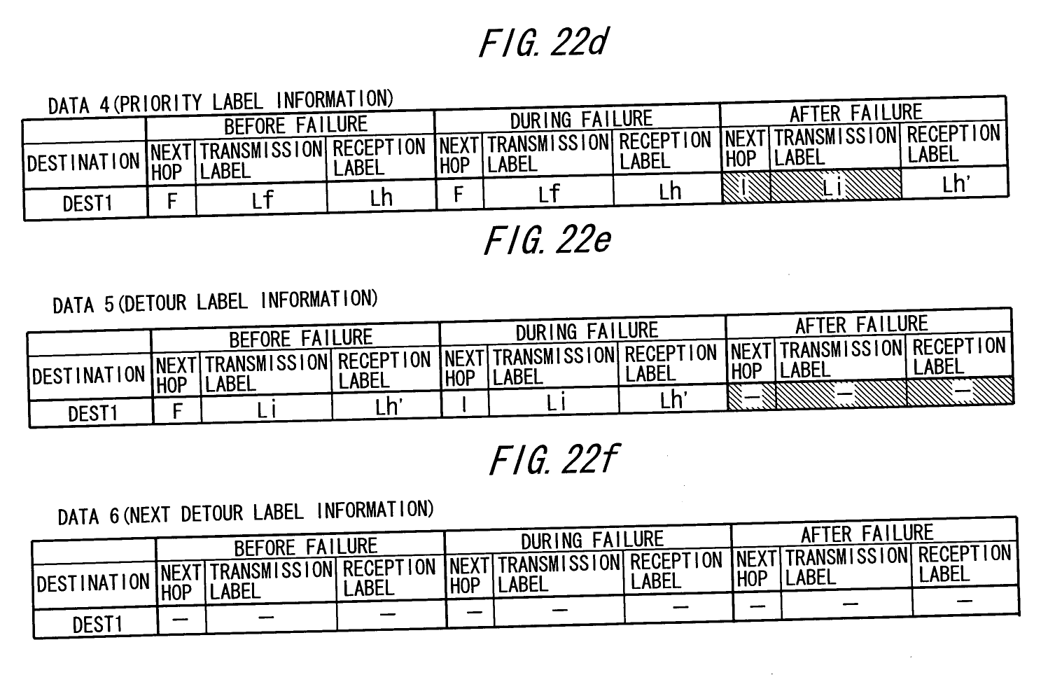

In addition, on the node H, as shown in “BEFORE FAILURE” in FIG. 22, the next hop (node F) on a priority path and the cost thereof and the next hop (node I) on a detour path and the cost thereof are registered to data 1, the next hop (node I) on the detour path and the cost and a priority 2 thereof are registered to data 2, label information Lf and label information Li advertised by the respective next hops (node F and node I) are registered to data 3, a priority reception label Lh and the priority transmission label Lf for the next hop (node F) on the priority path are registered to data 4, and a detour reception label Lh′ and the detour transmission label Li for the next hop (node I) on the detour path are registered to data 5. Note that a reception label and a transmission label for the next hop on the next detour path are not registered to the data 6 on the node H which has no next detour path as on the node B.

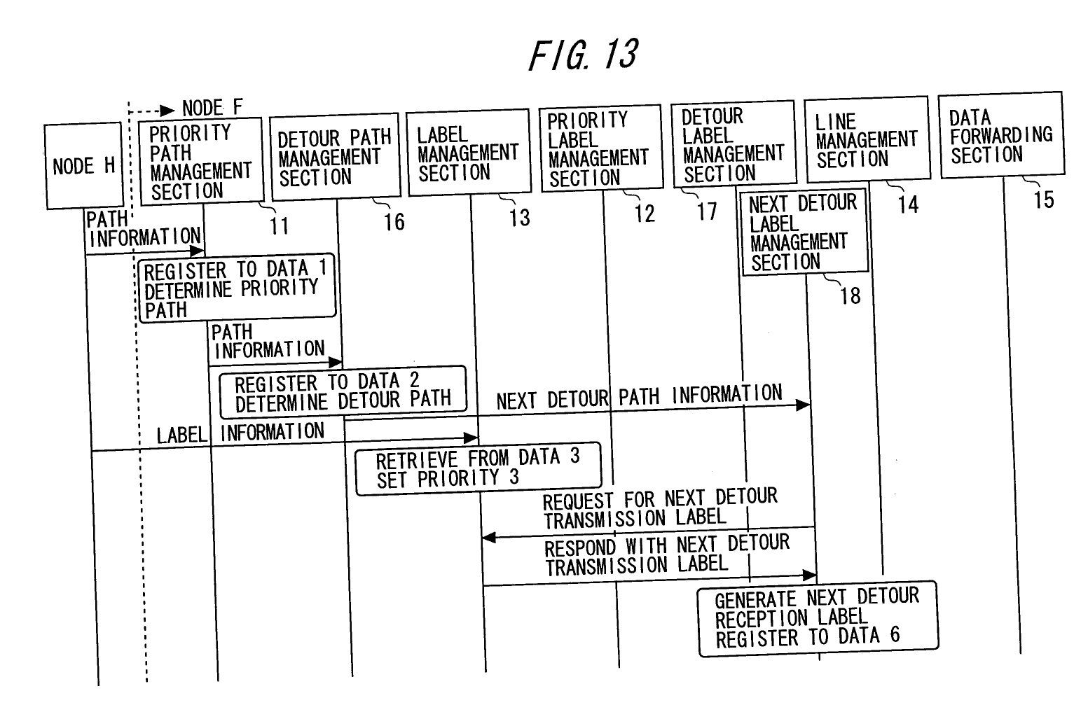

Further, on a node such as the node F, which includes multiple detour paths in addition to the priority path toward the destination dest1 from the node itself, processing is carried out according to a procedure shown in FIG. 13.

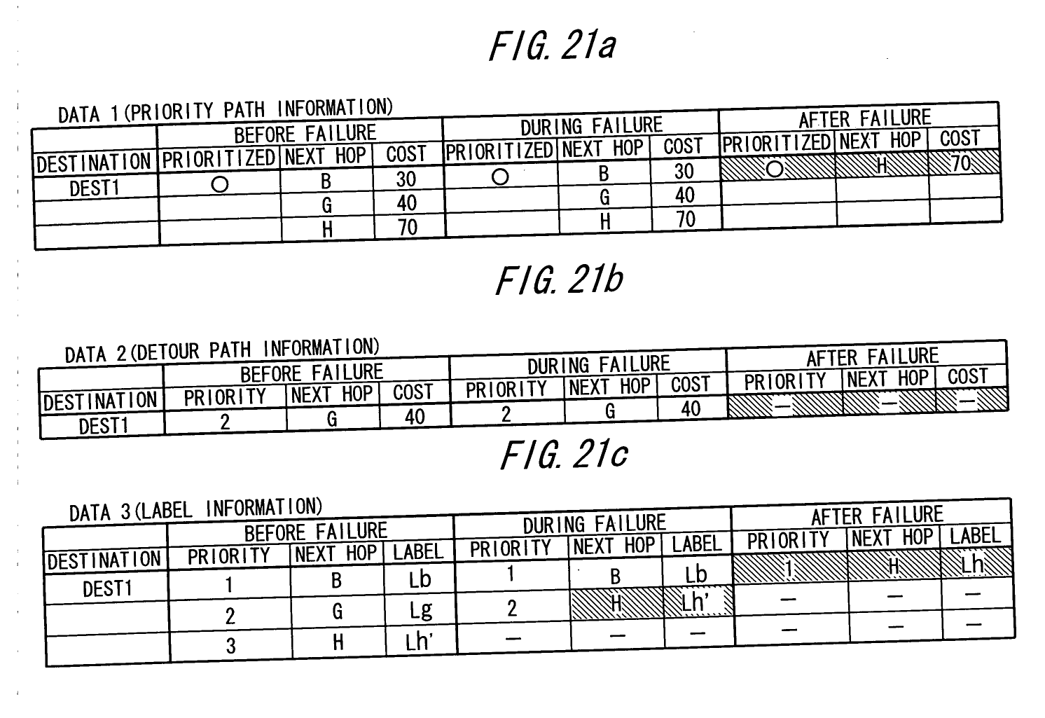

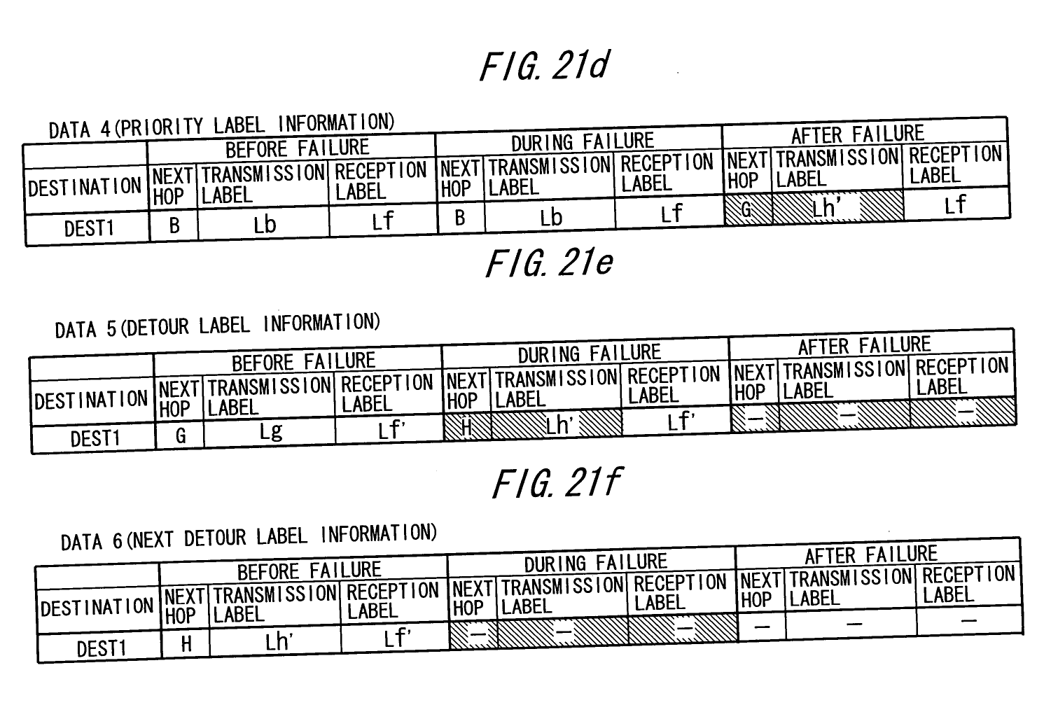

First, on the node F, the priority path management section 11 registers next hops (B, H, and G) on respective paths (F→B→C→A→D), (F→G→C→D), and (F→H→I→G→C→D), which are directed from the node F toward the destination dest1, and the costs thereof as path information based on path information from the neighboring nodes B, H, and G as shown in “BEFORE FAILURE” in FIG. 21(a). Then, a priority flag is set to a path with the lowest cost (next hop=node B) (setting of priority path information).

The detour path management section 16, which has been notified of the path information by the priority path management section 11, registers the next hop (node G) and the cost thereof on a path with the second lowest cost of the multiple (three) paths to the data 2 as detour path information.

The label management section 13 registers the label Lb, a label Lg, and the label Lh′, which have been advertised by the neighboring nodes B, G, and H, and then are associated with the respective nodes (next hops), to the data 3 as label information. Note that the node H has advertised the label Lh′, which is different in value from the label Lh to be advertised to the other paths, to the neighboring node F on the priority path (H→F→B→C→D) toward the destination dest1. The label Lh′ is thus registered to the data 3 corresponding to the neighboring node H (next hop) on the node F.

If there is a detour path (next hop (node H)) as a candidate ranked next to the detour path registered to the data 2, the detour path management section 16 notifies the next detour label management section 18 of the next detour path. The next detour label management section 18 requests from the label management section 13, the detour transmission label for the detour path (next hop (node H)), which is the next candidate. The label management section 13 notifies the next detour label management section 18 of the label Lh′, which corresponds to the applicable path information (next hop (node H)) as the next detour transmission label. The next detour label management section 18, which has received the notification, associates a reception label Lf′, which is a label advertised to the next hop (node B) on the priority path, and the next detour transmission label Lh′, which is notified by the label management section 13, with the next hop (node H) on the next detour path, and registers them to data 6 (next detour label information) as next detour label information (see “BEFORE FAILURE” in FIG. 21(f)) Note that the next detour label management section 18 manages a table which stores the data 6 (next detour label information). The table which stores the data 6 is created on a storage apparatus constituting the node like other tables.

Note that transmission labels and reception labels are registered to the data 4 and data 5 for the priority path identified by the next hop (node B), and the detour path identified by the next hop (node G) as in the first embodiment (refer to “BEFORE FAILURE” in FIGS. 21(d) and (e)).

In a state where the information on the priority path, the detour path, and the next detour path is registered on the respective nodes in this way, data, which has reached the node A, and is addressed to the destination dest1, is sequentially forwarded through the respective nodes, A, B, C, and D, on the priority path (A→B→C→D) toward the destination dest1 as in the first embodiment.

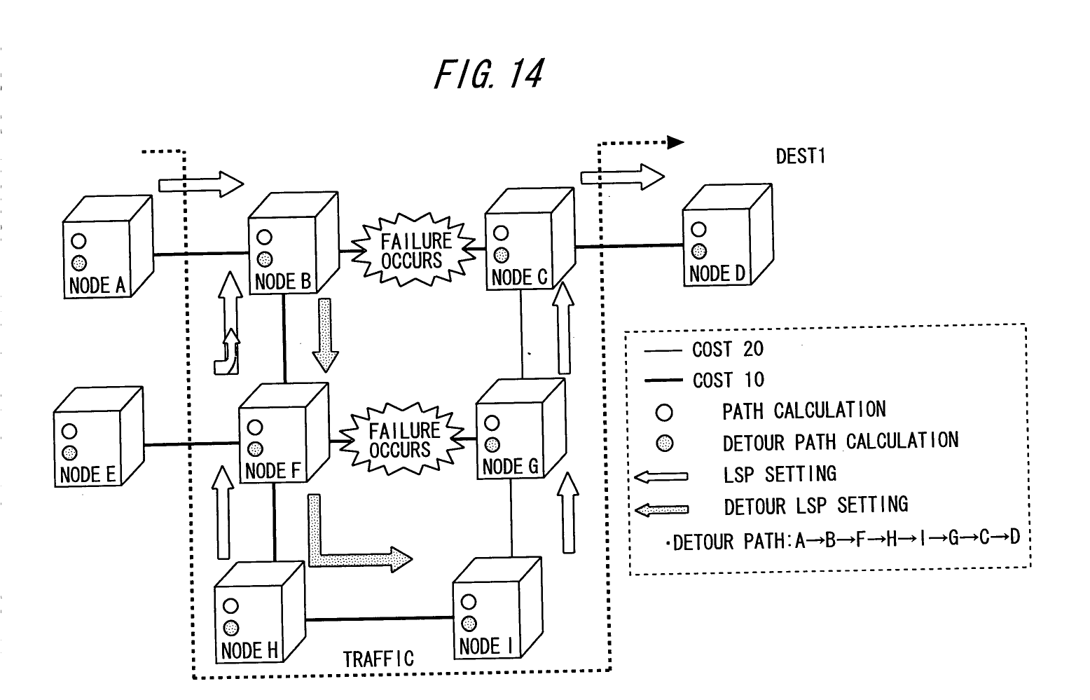

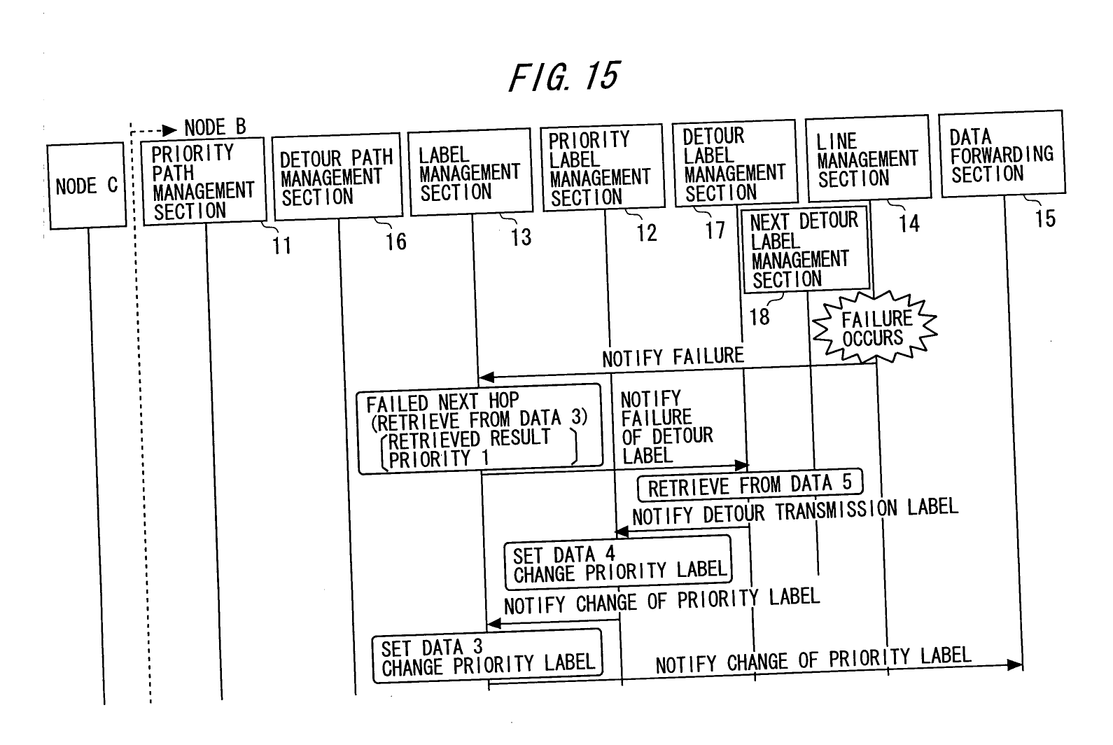

In this state, if the line management section 14 on the node B detects a failure, which has occurred on a line between the node B and node C as shown in FIG. 14, the priority path (next hop=node C) is switched to the detour path (next hop=node F) on the node B according to a procedure shown in FIG. 15 as in the first embodiment.

More specifically, the next hop is changed to the node F, and the transmission label information is rewritten to the label Lf′ corresponding to the node F in the priority label information in the data 4 (refer to “DURING FAILURE” in FIGS. 20(c) and (d)), and the detour label information is deleted in the data 5 (refer to “DURING FAILURE” in FIG. 20(e)). Then, a priority LSP of the data forwarding section 15 on the node B is updated to an LSP defined by a combination of the transmission label Lf′ and the reception label Lb with respect to the node F.

As a result, if data, which is addressed to the destination dest1 from the node A, reaches the node B (reception label Lb), the node B replaces the label Lb of the data with the label Lf′, and forwards the data to the node F.

Since the label Lf′ attached to the data is registered to the data 5 as the detour label information (refer to “BEFORE FAILURE” in FIG. 21(e)), the node F replaces the reception label Lf′ with the transmission label Lg based on the detour LSP (defined by the combination of the transmission label Lg and the reception label Lf′), and forwards the data to the node G. Processing as described above is carried out on the respective nodes, and consequently, the data forwarded from the node B to the node F is forwarded to the destination dest1 sequentially through the nodes G, C, and D on the detour path.

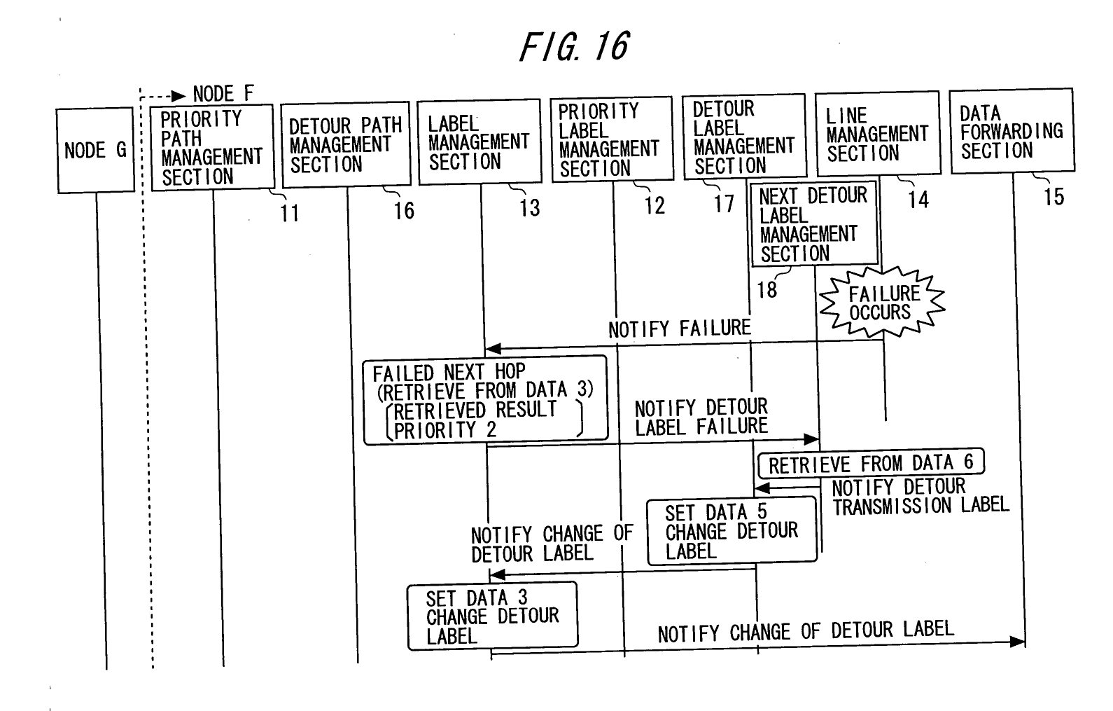

In this procedure, if the line management section 14 on the node F detects a failure, which has occurred on a line between the node F and node G as shown in FIG. 14, processing is carried out according to a procedure shown in FIG. 16 on the node F.

The line management section 14 notifies the label management section 13 of the occurrence of the failure. The label management section 13 retrieves the next hop in the failed line from the data 3 (refer to “BEFORE FAILURE” in FIG. 21(c)). If the applicable next hop is on the detour path (priority 2: next hop=node G), the label management section 13 notifies the next detour label management section 18 of the occurrence of the failure on the detour path. The next detour label management section 18 notifies the detour label management section 17 of the next detour transmission label Lh′ and the next hop H registered to the data 6, and deletes the information on the respective items including the next hop, transmission label, and reception label from the data 6 (refer to “DURING FAILURE” in FIG. 21(f)).

The detour label management section 17 sets the notified next detour transmission label Lh′ and the next hop (node H) to the data 5 as a detour transmission label (refer to “DURING FAILURE” in FIG. 21(e)) The detour label management section 17 then notifies the label management section 13 of the information.

The label management section 13 sets the notified label Lh′ and the next hop (node H) to the data 3 as path information with the priority 2 (refer to “DURING FAILURE” in FIG. 21(c)), and notifies the data forwarding section 15 of the label Lh′ as the transmission label for the detour path. The data forwarding section 15 consequently registers a detour LSP defined by the transmission label Lh′ and the reception label Lf′.

The detour LSP consequently is switched from the next hop (=node G) to the next hop (=node H) on the node F. As a result, if data attached with the label Lf′ reaches the node F from the node B, the node F replaces the label Lf′ with the label Lh′, and forwards the data to the node H.

On the node H, which has received the data attached with the label Lh′, the label Lh′ is registered to the data 5 as the detour label information (refer to “DURING FAILURE” in FIG. 22(e)), so the label Lh′ is replaced by the label Li, and the data is forwarded to the node I based on the detour LSP (defined by a combination of the transmission label Li and the reception label Lh′). Processing as described above is carried out on the respective nodes, and consequently, the data, which has been forwarded from the node B to the node F, is forwarded to the destination dest1 sequentially through the nodes H, I, G, C, and D on the next detour path.

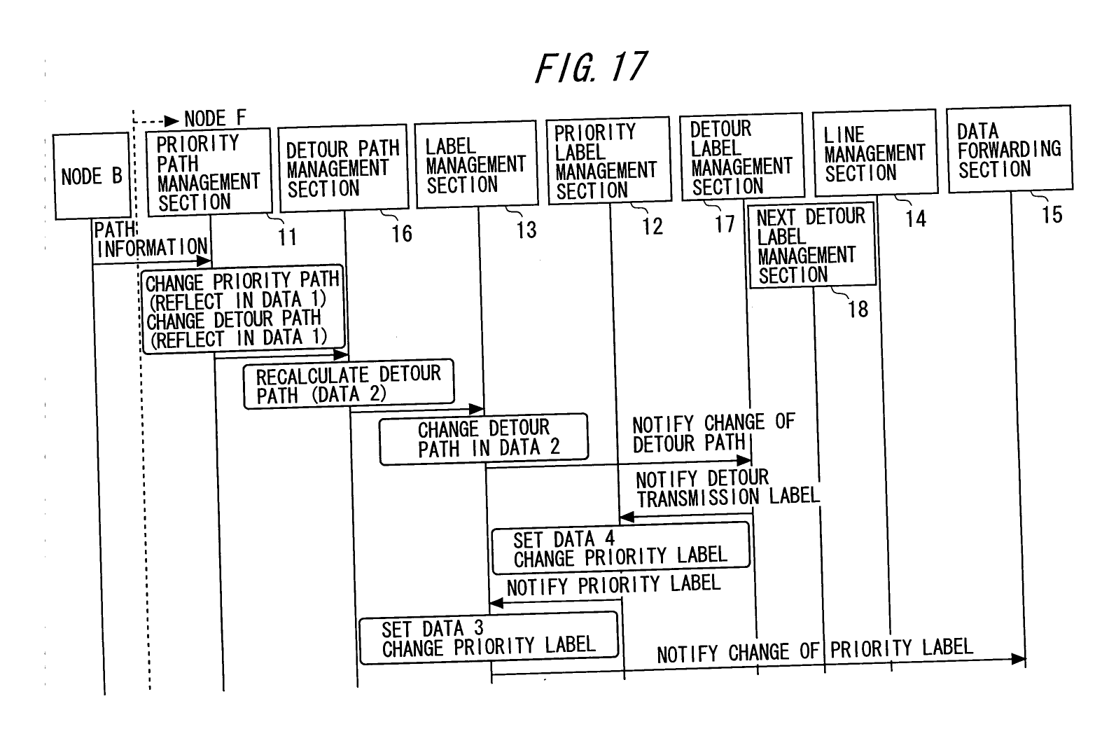

If a certain period has elapsed since the line failures, and a timing for path reset is reached, processing is carried out on the node F according to a procedure shown in FIG. 17.

The priority path management section 11 carries out recalculation based on the path information advertised by the neighboring nodes, consequently determines the node H as the next hop on the priority path, and deletes the respective path information on the next hop (=node B) and the next hop (=node G) from the data 1 (refer to “AFTER FAILURE” in FIG. 21(a)). Then, the priority path management section 11 notifies the detour path management section 16 of the deletion. There is no next candidate for the detour path, the detour path management section 16 thus notifies the label management section 13 of the absence.

The label management section 13 deletes the detour path in the data 2 (refer to “AFTER FAILURE” in FIG. 21(b)), and notifies the detour label management section 17 of the deletion. The detour label management section 17 notifies the priority label management section 12 of the next hop (=node H) on the priority path after the path recalculation, and the transmission label Lh′, and deletes the information on the respective items including the next hop, transmission label, and reception label of the data 5 (refer to “AFTER FAILURE” in FIG. 21(e)).

The priority label management section 12 updates the next hop and the transmission label of the data 4 to the node H and the label Lh′ (refer to “AFTER FAILURE” in FIG. 21(d)), and notifies the label management section 13 of the update. The label management section 13 updates the label information of the data 3 to the notified node H and label Lh′ (refer to “AFTER FAILURE” in FIG. 21(c)). An LSP with the transmission label Lh′ is then registered to the data transmission section 15.

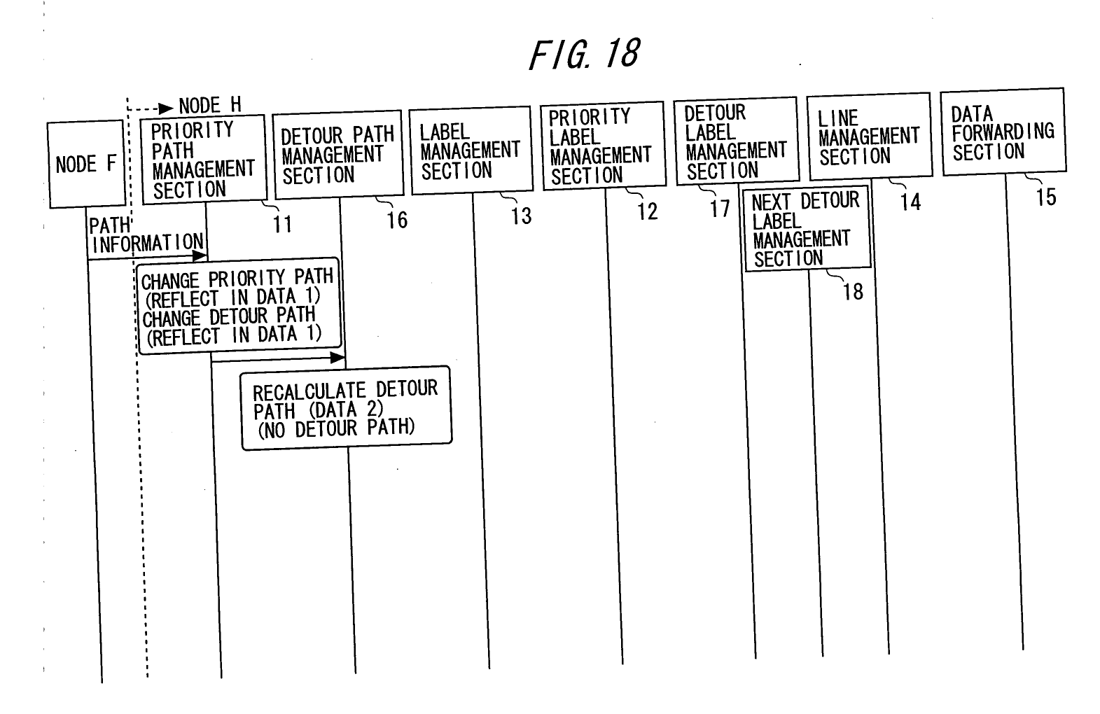

In addition, processing is carried out on the neighboring node H of the node F according to a procedure shown in FIG. 18. More specifically, as a result of exchange of path information between the neighboring nodes F and I, the priority path management section 11 sets the path, which has been registered as the detour path until now, to the data 1 as a priority path (refer to “AFTER FAILURE” in FIG. 22(a)). If the priority path management section 11 then notifies the detour path management section 16 of the setting, the detour path management section 16 recalculates the detour path. In this case, there remains no detour path, and the information relating to the detour path (next hop=node G, cost 40) is thus deleted in the data 2 (refer to “AFTER FAILURE” in FIG. 21(b)).

In addition, as “AFTER FAILURE” in FIG. 22(c) shows, the label information with the priority 1 in the data 3 is updated to the next hop (node I) relating to the new priority path, and label information Li thereof. The detour label information in the data 5 is then deleted (refer to “AFTER FAILURE” in FIG. 22(e)), and simultaneously, the next hop (node I), the reception label Lh′, and the transmission label Li relating to the new priority path are registered to the data 4 as the priority label information (refer to “AFTER FAILURE” in FIG. 22(d)).

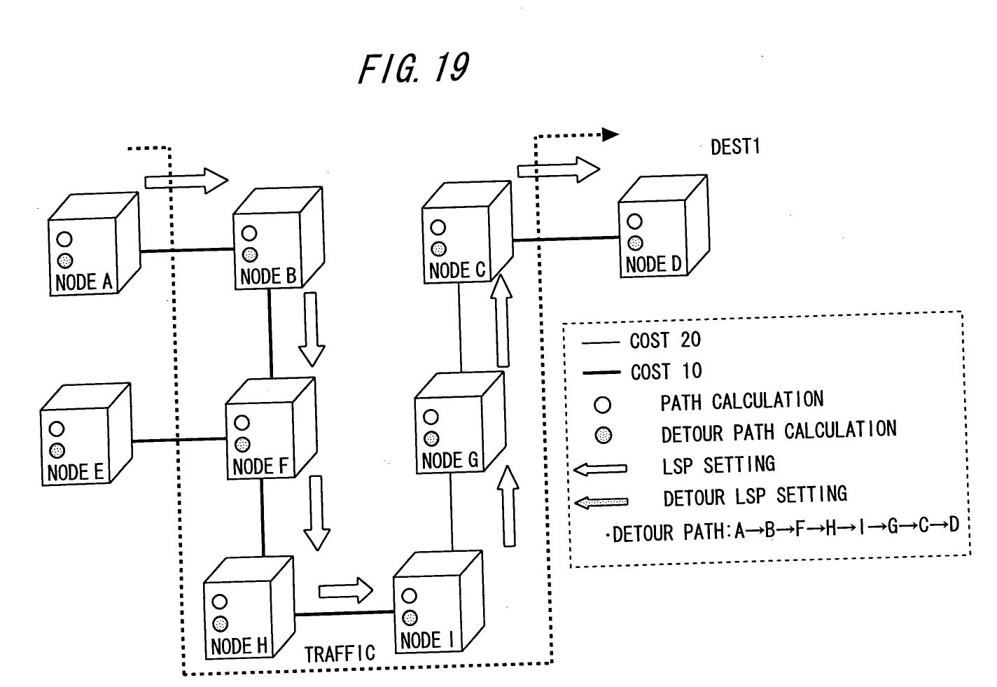

The MPLS network is reconfigured as shown in FIG. 19 as a result of the processing on the respective nodes as described above. Consequently, data, which has reached the node B from the node A, is forwarded toward the destination dest1 sequentially through the node F, node H, node I, node G, node C, and node D while the label thereof is being replaced.

According to the second embodiment, if failures occur successively between the node B and node C, and between the node F and node G within an interval between the timings of the path resetting, the LSP's are switched to forward data on the next detour paths provided in advance. As a result, it is possible to prevent a traffic disconnection until the path resetting.

Note that even if the detection timings of the failures between the node B and node C, and between the node F and node G, are opposite to the above description, the control is carried out such that the data is finally forwarded on the next detour path.

In addition, according to the configuration described in the second embodiment, while a failure on the priority path is not detected on a certain node (such as node F) having multiple detour paths, if a failure is detected on the detour path, the data 2 to data 6 are rewritten and the detour LSP is set such that the next detour path is set to a detour path.

### Third Embodiment

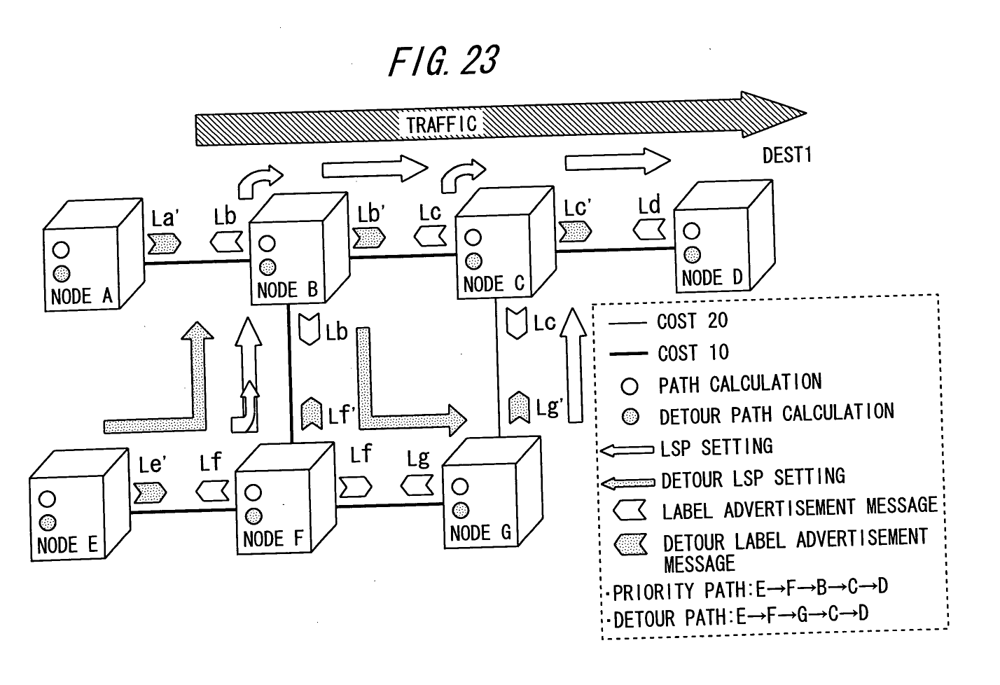

A description will now be given of an MPLS network according to a third embodiment of the present invention. This MPLS network is configured as shown in FIG. 23, for example, and is different from the MPLS network according to the first embodiment in that a detour label monitoring section 19 (refer to FIG. 3) effectively functions on respective nodes. Note that the detour label monitoring section 19 functions as label monitoring means according to the present invention, and the data forwarding section 15 functions as first and second path switching means according to the present invention.

The MPLS network shown in FIG. 23 has a configuration similar to that of the first embodiment. In short, this MPLS network includes the seven nodes A to G, which respectively function as a label switching router (LSR) or a label edge router (LER), and the connection form of these routers is similar to that of the MPLS network shown in FIG. 2. On this MPLS network, if a traffic from the node E toward the destination dest1 is focused, a path (E→F→B→C→D) is a priority path, and a path (E→F→G→C→D) is a detour path.

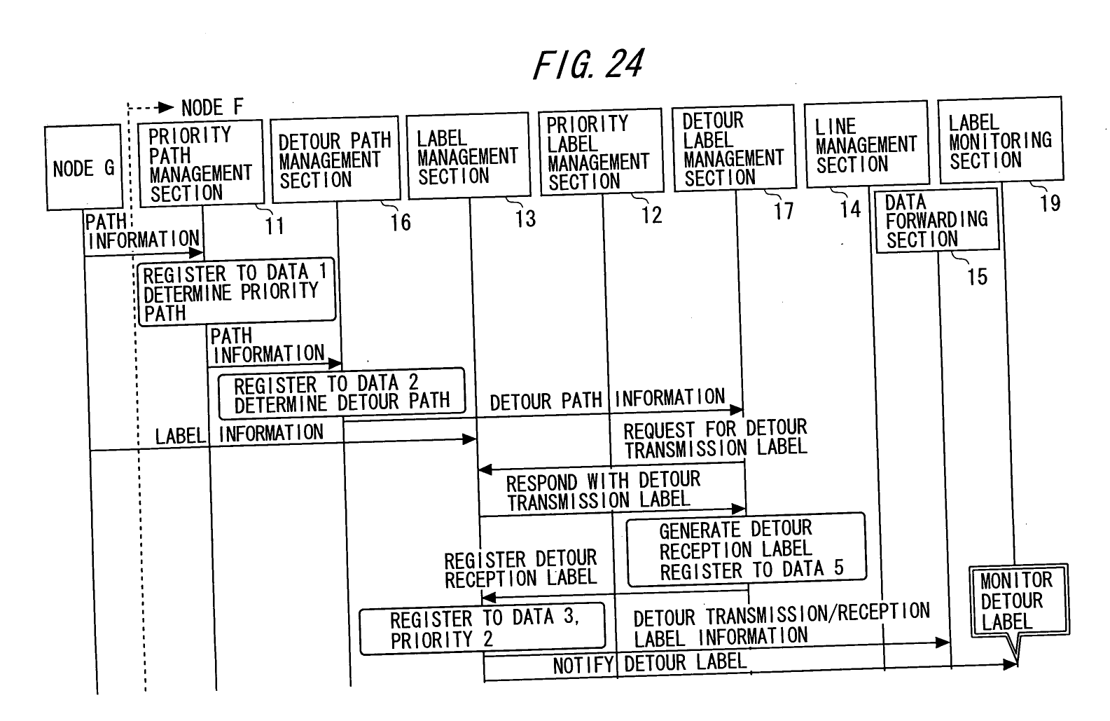

The respective nodes on the MPLS network configured in this way carry out processing according to the procedure shown in FIG. 4 basically in the same manner as in the first embodiment before starting forwarding of data. In addition, processing according to a procedure shown in FIG. 24 is carried out for a detour path in place of the processing procedure shown in FIG. 5. Taking the node F as an example, the detour label management section 17 notifies the label management section 13 of a detour LSP (defined by a detour reception label Lf′ and a detour transmission label Lg). The label management section 13 transmits the notified detour LSP to the detour label monitoring section 19. As a result, the detour label monitoring section 19 is caused to monitor whether the label attached to forwarded data is the detour reception label Lf′ of the detour LSP or not.

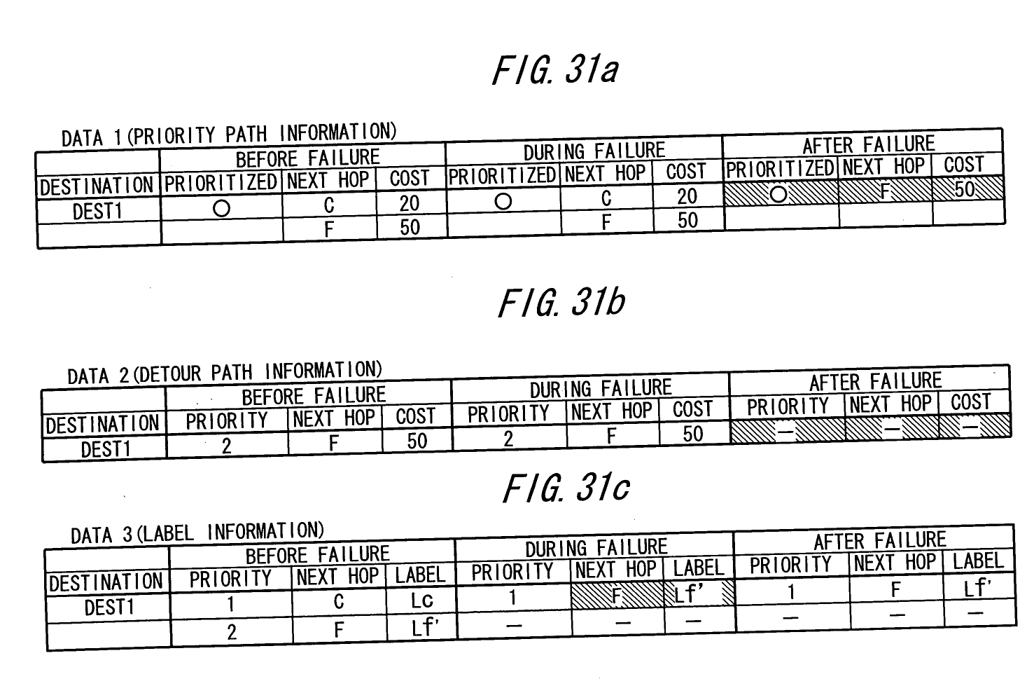

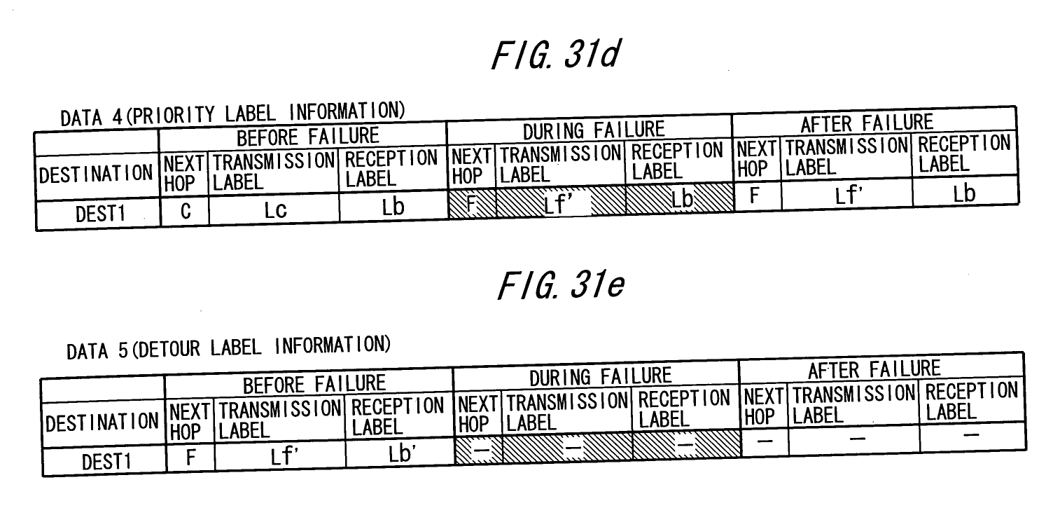

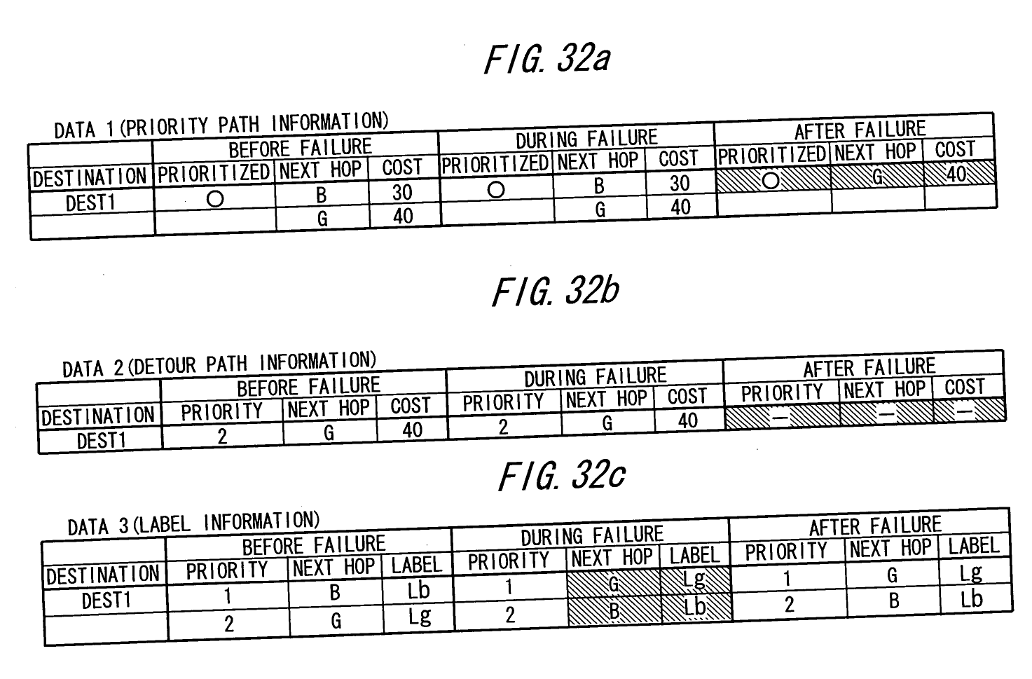

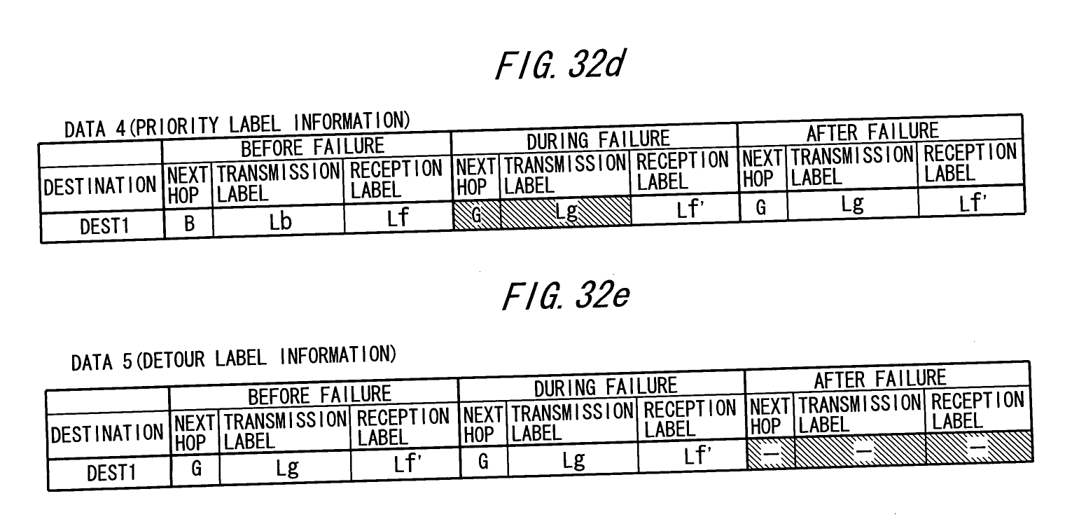

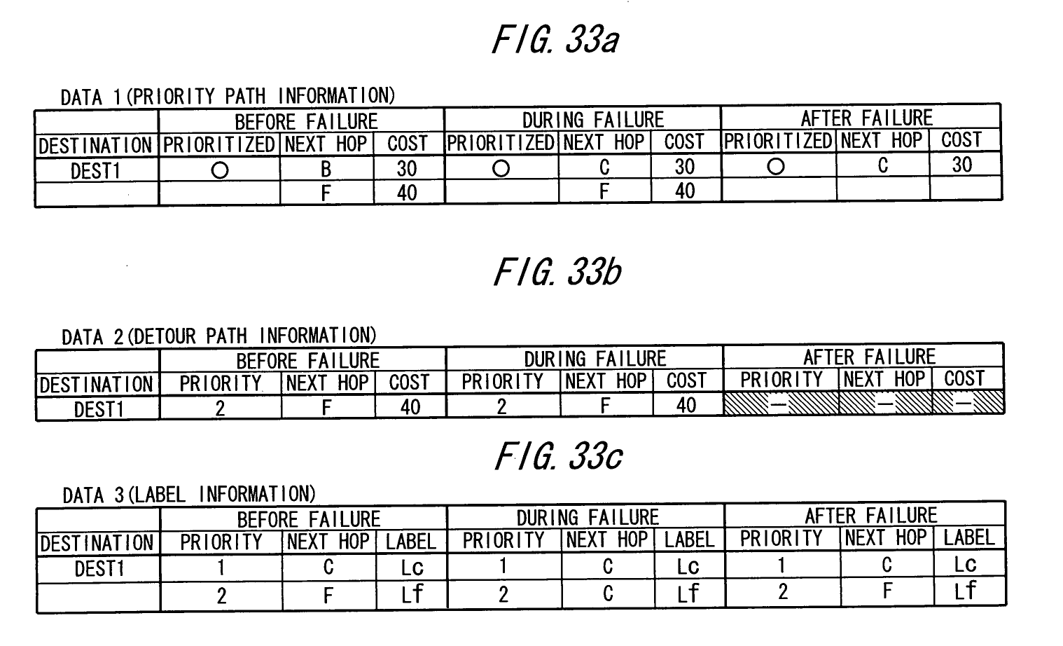

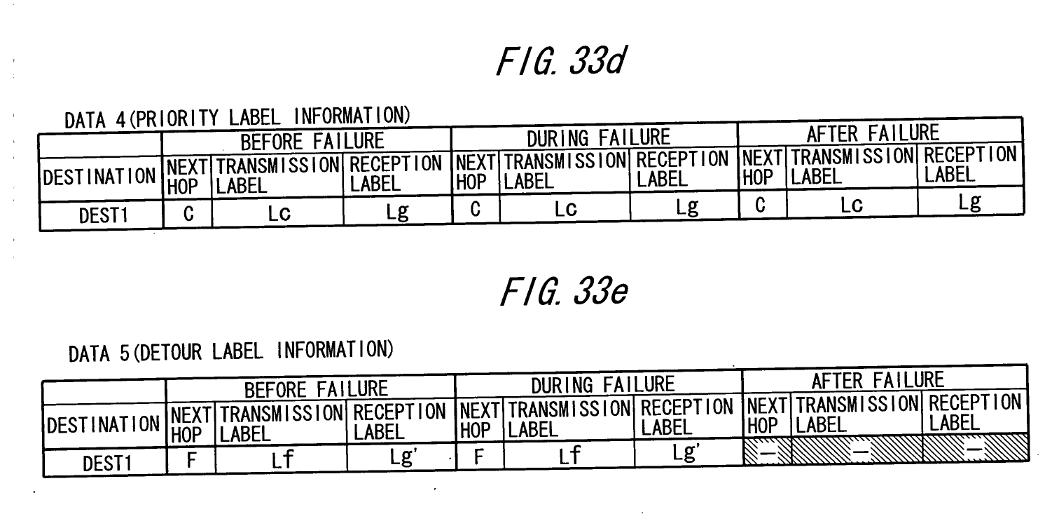

As a result of the processing described above, path information and label information relating to a priority path and a detour path on the respective nodes such as the node B are registered to data 1 to data 5 as shown in “BEFORE FAILURE” in FIG. 31(a), for example. These contents are the same as those in the first embodiment (refer to “BEFORE FAILURE” in FIG. 10(a)). Additionally, path information and label information relating to a priority path and a detour path on the node F, for example, are registered to the data 1 to data 5 as shown in “BEFORE FAILURE” in FIG. 32(a), for example. These contents are also the same as those in the first embodiment (refer to “BEFORE FAILURE in FIG. 11(a)”). Further, path information and label information relating to a priority path and a detour path on the node G are registered to the data 1 to data 5 as shown in “BEFORE FAILURE” in FIG. 33(a), for example.

As a result, to the data forwarding section 15 on the node B are registered a priority LSP defined by a priority transmission label Lc and a priority reception label Lb, and simultaneously, a detour LSP defined by the detour transmission label Lf′ and a detour reception label Lb′ (refer to “BEFORE FAILURE” in FIGS. 31(d) and (e)). In addition, to the data forwarding section 15 on the node F are registered a priority LSP defined by the priority transmission label Lb and a priority reception label Lf, and simultaneously, a detour LSP defined by the detour transmission label Lg and the detour reception label Lf′ (refer to “BEFORE FAILURE” in FIGS. 32(d) and (e)). Further, to the data forwarding section 15 on the node G are registered a priority LSP defined by the priority transmission label Lc and the priority reception label Lg, and simultaneously, a detour LSP defined by the detour transmission label Lf and a detour reception label Lg′ (refer to “BEFORE FAILURE” in FIGS. 33(d) and (e)).

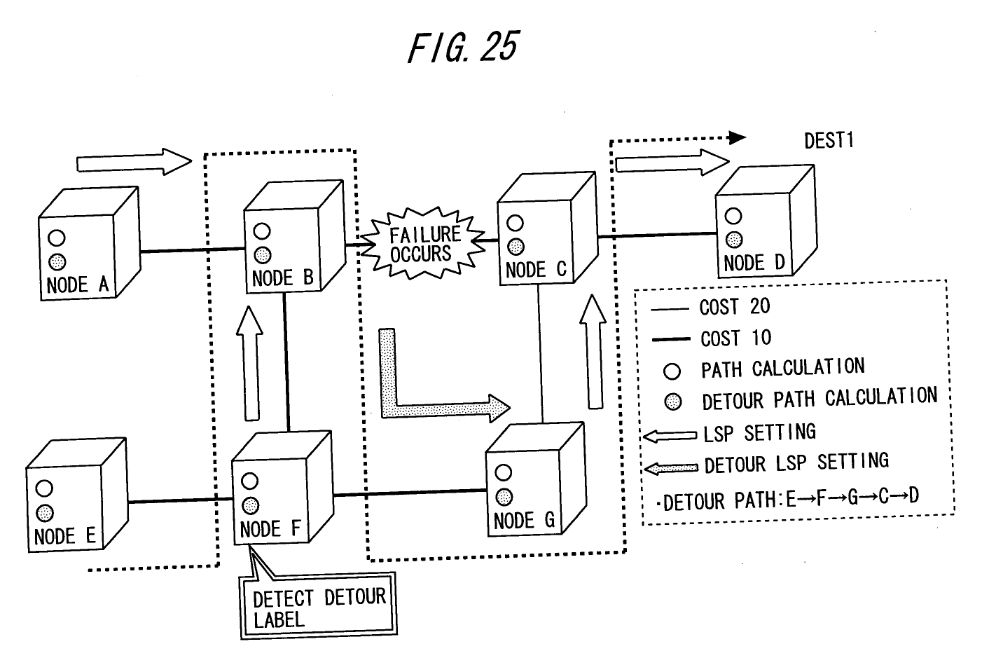

On the MPLS network where the priority LSP and detour LSP are defined on the respective nodes as described above, if data addressed to the dest1 reaches the node F from the node E, the data is forwarded to the destination dest1 sequentially on the priority path (F→B→C→D) while the label thereof is being replaced. In this state, if a failure occurs on a line between the node B and node C as shown in FIG. 25, for example, the following operation is carried out on the MPLS network.

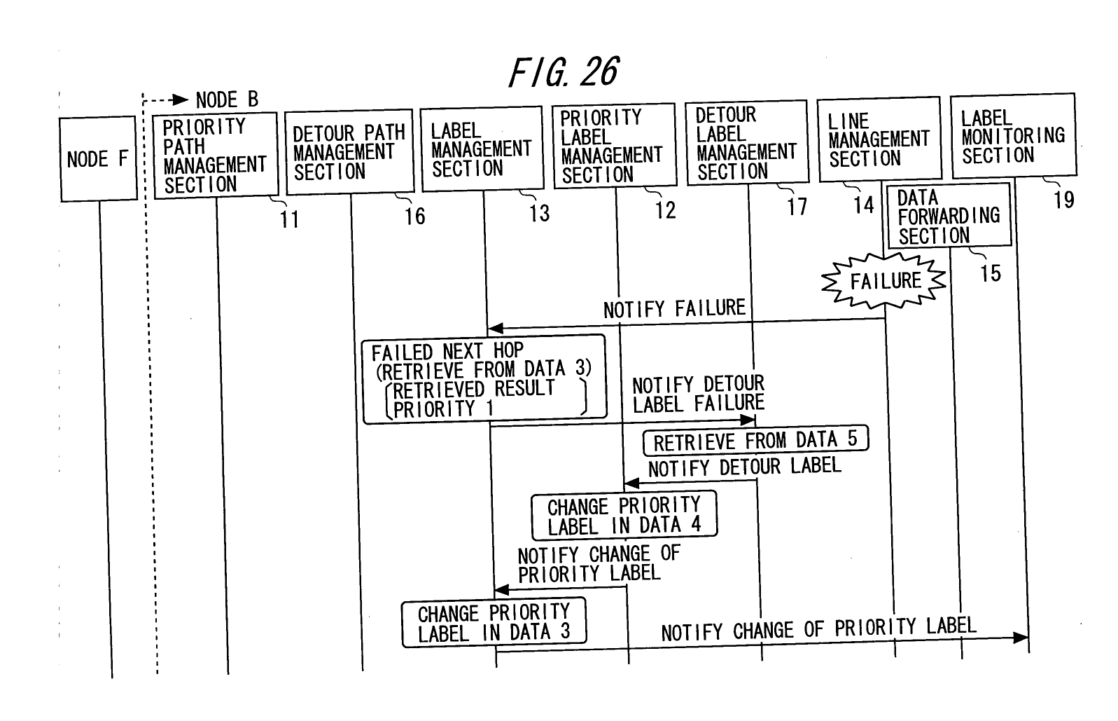

If the node B detects the failure on the line, the node B switches the priority LSP so as to be directed toward the node F according to a procedure shown in FIG. 26 (corresponding to the procedure shown in FIG. 7). As a result, data, which has been transmitted from the node F to the node B, and is addressed to the destination dest1, is returned at the node B to the node F (see a thick broken line in FIG. 25).

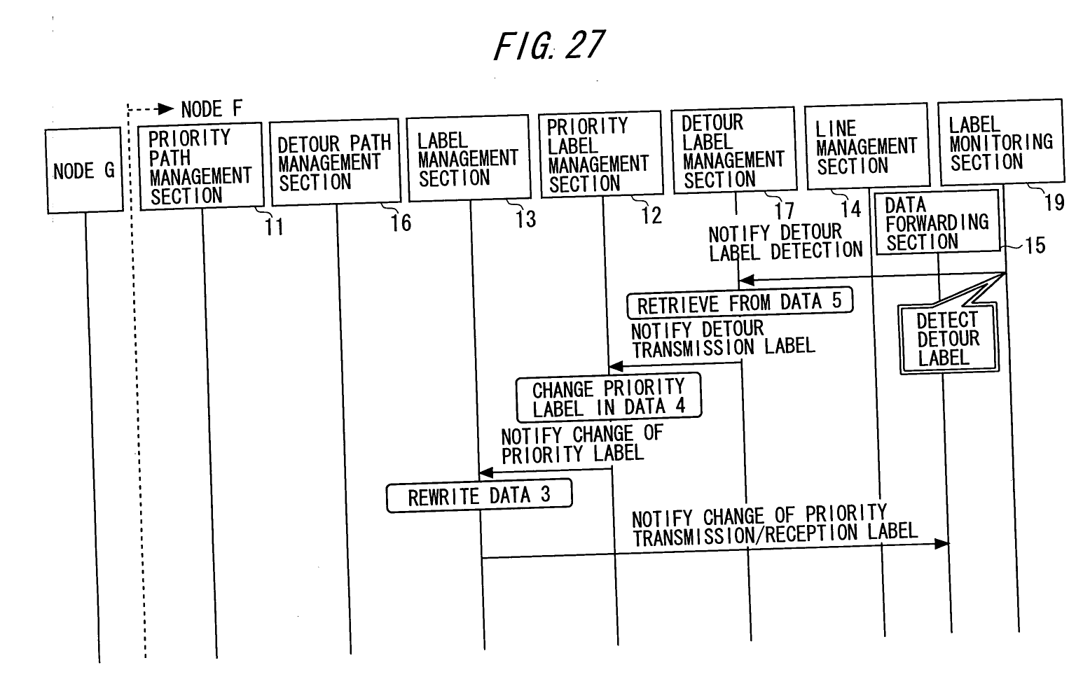

In addition, processing is carried out according to a procedure shown in FIG. 27 on the node F. Namely, if the detour label monitoring section 19 detects that the label of the data forwarded by the node B is Lf′, the label monitoring section 19 notifies the detour label management section 17 of the label. The detour label management section 17 retrieves the corresponding detour reception label Lf′ from the data 5 (refer to “DURING FAILURE” in FIG. 32(e)), and notifies the priority label management section 12 of the corresponding detour transmission label Lg and the next hop (node G). The priority label management section 12 sets the notified detour transmission label Lg and the next hop (=node G) as a priority LSP to data 4 (refer to “DURING FAILURE” in FIG. 32(d)), and notifies the label management section 13 of the setting. The label management section 13 rewrites the data 3 with an LSP, which is a combination of the notified priority transmission label Lg, priority reception label Lf′, and next hop (=node G) (refer to “DURING FAILURE” in FIG. 32(c)), and registers the LSP to the data forwarding section 15 as the priority LSP.

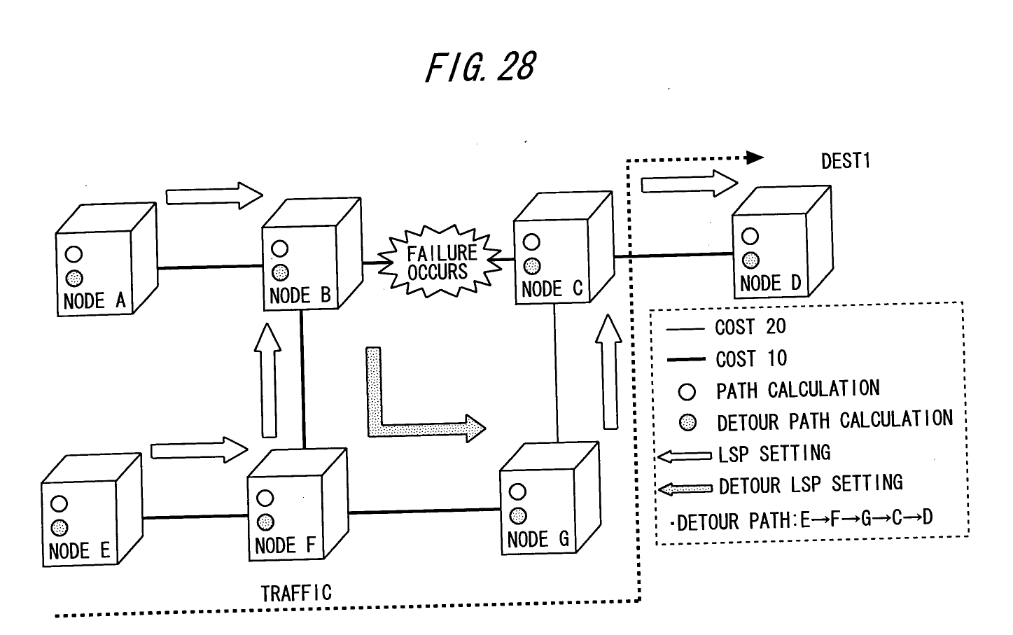

Consequently, the label Lf′ of the data returned to the node F by the node B is replaced with the priority transmission label Lg, and the data is forwarded to the node G. Subsequently, the data forwarded to the node F by the node E is forwarded toward the destination dest1 sequentially through the respective nodes, G→C→D, as shown in FIG. 28.

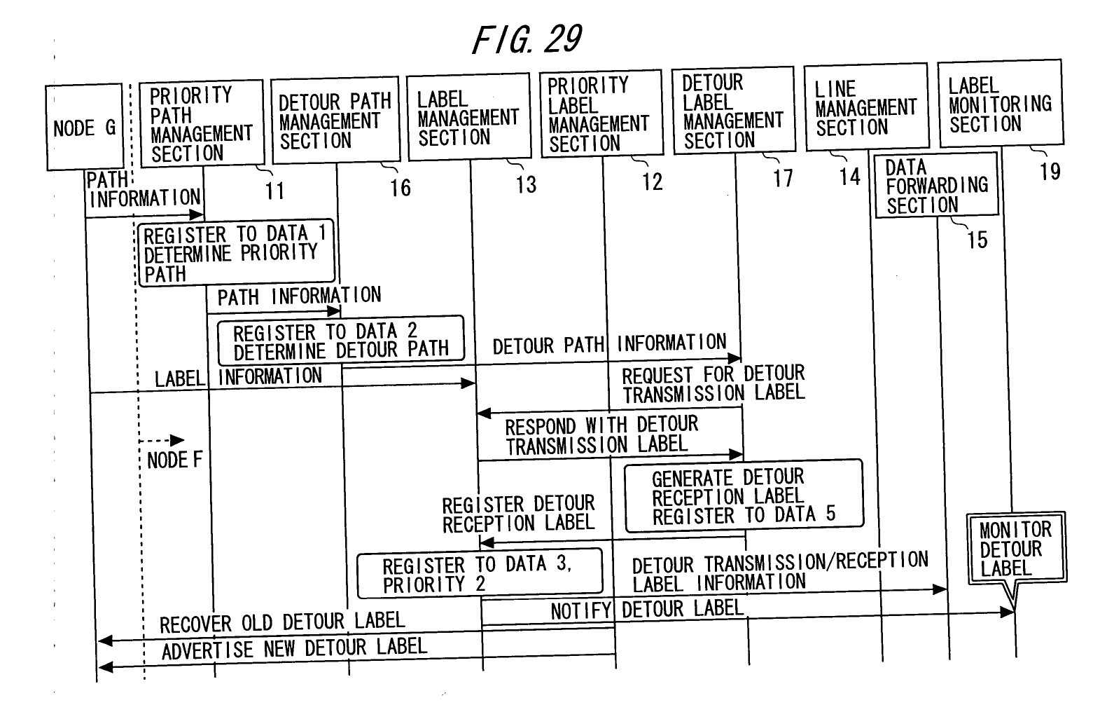

If timing for path redesign is reached after a certain period has elapsed since the occurrence of the failure, processing is carried out basically according to a procedure shown in FIG. 29 on the respective nodes, such as the node B, node F, and node G.

More specifically, the priority path management section 11 updates the data 1 based on a result of the path redesign. For example, the next hop (=node F) is set to the priority path, and the next hop (=node C) is deleted on the node B, (refer to “AFTER FAILURE” in FIG. 31(a)). The priority path management section 11 notifies the detour path management section 16 of the change of the detour path. The detour path management section 16 changes the detour path in the data 2, and notifies the detour label management section 17 of the change. In this case, there is no new detour path, the detour label management section 17 deletes the detour transmission label and the next hop from the data 5 (refer to “AFTER FAILURE” in FIG. 31(b)), and notifies the label management section 13 of the deletion. The label management section 13 notifies the data forwarding section 15 of the detour LSP, thereby deleting the LSP.

Further, the old detour label is recovered, and simultaneously the new detour label is advertised on the node F, for example.

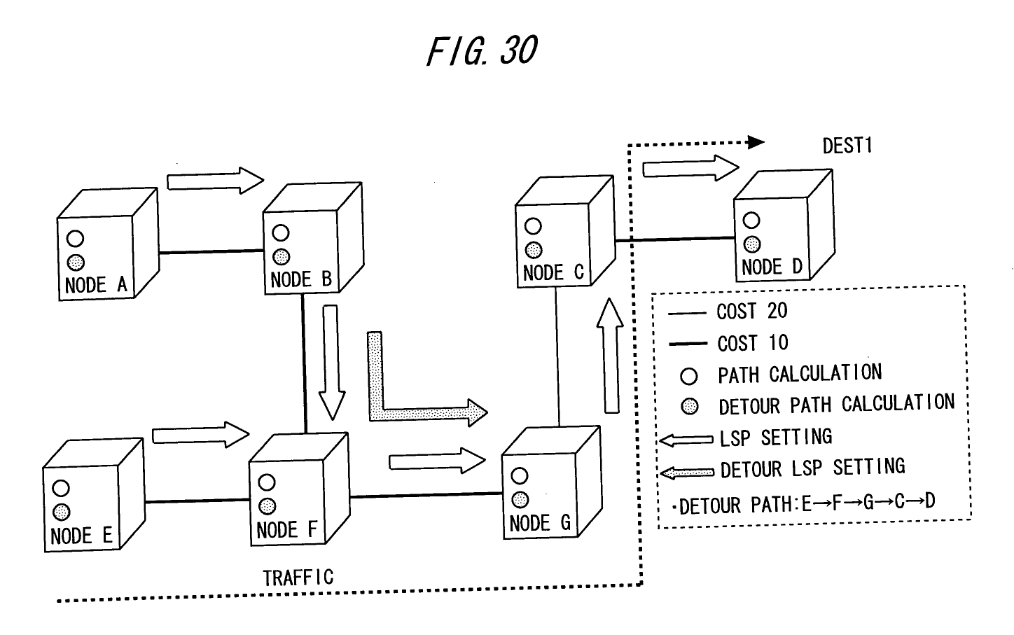

The processing described above sets the data 1 to data 5 on the respective nodes as shown in “AFTER FAILURE” respectively in FIG. 31 to FIG. 33. As a result, in this MPLS network, as shown in FIGS. 30a-30e, data, which has reached the node E and is addressed to the destination dest1, is sequentially forwarded through the respective nodes, E→F→G→C→D.

According to the third embodiment, if the node F receives data attached with the label value, which has been advertised to the neighboring node corresponding to the next hop on the priority path (if data, which has been forwarded to the next hop on the priority path, returns to the node itself), the node F recognizes an occurrence of a failure, and forwards the data to be forwarded to the next hop (node B) on the priority path to the next hop (node G) on the detour path. The data received by the node F thus is forwarded toward the node G without repeating a round trip between the node F and node B. Consequently, it is possible to restrain a delay of the traffic, and the waste of the network resource between the node B and node F.

<<Others>>

Further, the embodiments of the present invention disclose the claimed inventions. In addition, components included in any one of the claimed respective inventions may be combined with components included in other claims.

As described above, the MPLS networks according to the present invention are effective as an MPLS network including respective nodes as a label switching router, which provides the effect of shortening a period of the traffic disconnection as much as possible, and easily switching paths, and has the function of switching from a path on which a failure occurs, to a detour path in case of failure.

What is claimed is:

1. A multi protocol label switching (MPLS) network system including a plurality of nodes, each of which functions as a label switching router or a label edge router, each of the nodes comprising:
a priority path management section managing a label, which is advertised by a neighboring node corresponding to a next hop on a priority path, designating as a priority transmission label, and pairing with a label advertised by the node itself;
a first detour path management section managing a label, which is advertised by a neighboring node corresponding to a next hop on a first detour path, designating as a detour transmission label, and pairing with a label advertised by the node itself;
a failure detection section detecting a failure between the node itself and the neighboring node; and
a first path switching section, if the failure detection section detects a failure between the neighboring node corresponding to the next hop on the priority path and the node itself, replacing the label, which is attached to data to be forwarded to the neighboring node corresponding to the next hop on the priority path and advertised by the node itself, with the detour transmission label instead of the priority transmission label, and forwarding the data to the neighboring node corresponding to the next hop on the detour path.

2. The MPLS network system according to claim 1, wherein each of the nodes further comprises:
a section that advertises a first label to the neighboring node corresponding to the next hop on the priority path; and
a section that advertises a second label different from the first label to a neighboring node on a path other than the priority path; and
the first detour path management section manages the detour transmission label which is paired with the first label.

3. The MPLS network system according to claim 2, wherein each of the nodes further comprises:
a second detour path management section managing a label, which is advertised by a neighboring node corresponding to a next hop on a second detour path, designated as a next detour transmission label, and paired with the label advertised by the node itself; and
a second path switching section that, if the failure detection section detects a failure between the node itself and the neighboring node corresponding to the next hop on the first detour path, replaces the label which is attached to data to be forwarded to the neighboring node corresponding to the next hop on the first detour path, and has been advertised by the node itself, with the next detour transmission label instead of the detour transmission label, and forwards the data to the neighboring node corresponding to the next hop on the second detour path.

4. The MPLS network system according to claim 2, wherein each of the nodes further comprises:
a label monitoring section that monitors the label, which is advertised by the node itself and is attached to data forwarded by a neighboring node; and
a second path switching section that, if the label monitoring section detects, as the first label, the label advertised by the node itself, replaces the first label which is attached to the forwarded data with the detour transmission label, and forwards the forwarded data to the neighboring node corresponding to the next hop on the first detour path.

5. The MPLS network system according to claim 4, wherein after the label monitoring section detects that the label advertised by the node itself is the first label, the first path switching section replaces the label, which is attached to the data to be forwarded to the neighboring node corresponding to the next hop on the priority path and advertised by the node itself, with the detour transmission label instead of the priority transmission label, and forwards the data to the neighboring node corresponding to the next hop on the first detour path.

6. A node which functions as a label switching router or a label edge router constituting a multi protocol label switching (MPLS) network, comprising:
a priority path management section managing a label, which is advertised by a neighboring node corresponding to a next hop on a priority path, designating as a priority transmission label, and pairing with a label advertised by the node itself;
a first detour path management section managing a label, which is advertised by a neighboring node corresponding to a next hop on a first detour path, designating as a detour transmission label, and pairing with a label advertised by the node itself;
a failure detection section detecting a failure between the node itself and the neighboring node; and
a first path switching section, if the failure detection section detects a failure between the neighboring node corresponding to the next hop on the priority path and the node itself, replacing the label, which is attached to data to be forwarded to the neighboring node corresponding to the next hop on the priority path and advertised by the node itself, with the detour transmission label instead of the priority transmission label, and forwarding the data to the neighboring node corresponding to the next hop on the detour path.

7. The node according to claim 6, further comprising:
a section that advertises a first label to the neighboring node corresponding to the next hop on the priority path; and
a section that advertises a second label different from the first label to a neighboring node on a path other than the priority path,
wherein the first detour path management section manages the detour transmission label which is paired with the first label.

8. The node according to claim 7, further comprising:
a second detour path management section that manages a label, which is advertised by a neighboring node corresponding to a next hop on a second detour path, designated as a next detour transmission label, and paired with the label advertised by the node itself; and
a detour path switching section that, if the failure detection section detects a failure between the neighboring node corresponding to the next hop on the detour path and the node itself, replaces the label, which is attached to the data to be forwarded to the neighboring node corresponding to the next hop on the detour path and advertised by the node itself, with a next detour transmission label instead of the detour transmission label, and forwards the data to the neighboring node corresponding to the next hop on the second detour path.

9. The node according to claim 7, further comprising:
a label monitoring section that monitors the label which is attached to the data forwarded by a neighboring node and is advertised the node itself;
a second path switching section that, if the label monitoring section detects that the label which is advertised by the node itself is the first label, replaces the first label, which is attached to the forwarded data, with the detour transmission label, and forwards the data to the neighboring node corresponding to the next hop on the first detour path.

10. The node according to claim 9, wherein, after the label monitoring section detects that the label advertised by the node itself is the first label, the first path switching section replaces the label, which is attached to the data to be forwarded to the neighboring node corresponding to the next hop on the priority path and advertised by the node itself, with the detour transmission label instead of the priority transmission label, and forwards the data to the neighboring node corresponding to the next hop on the first detour path.
